(19) United States
(12) Patent Application Publication
(10) Pub. No.: US 2015/0121254 A1
(43) Pub. Date: Apr. 30, 2015

(54) FOOD FEEDBACK INTERFACE SYSTEMS AND METHODS

(71) Applicant: FOOD FEEDBACK, INC., San Francisco, CA (US)

(72) Inventors: Denise M. DUFFY, San Francisco, CA (US); Melissa A. CAMERON, San Francisco, CA (US)

(73) Assignee: FOOD FEEDBACK, INC., San Francisco, CA (US)

(21) Appl. No.: 14/523,754

(22) Filed: Oct. 24, 2014

Related U.S. Application Data
(60) Provisional application No. 61/895,260, filed on Oct. 24, 2013.

(51) Int. Cl. H04L 29/06; G06F 3/0484

(52) U.S. Cl. CPC H04L 65/403; G06F 3/04842
USPC 715/753

(57) ABSTRACT

An interface, computer-implemented process, and system are provided to facilitate a community for sharing food choices in an online social forum (e.g., in a crowd sourced feedback forum) or network. A process includes receiving an image of food by a first user (e.g., from a user's smartphone camera), causing communication of the image of the food for delivery to devices of other users, and receiving comments from at least one other user based on the communicated image of the food. The comments may then be communicated back to the original user as feedback on the food. The images may be shared only with selected other users, e.g., coaches. One or more other users or coaches may be selected to receive a first user's images based on a user's profile, responses to questions, desires of the user, pre-selection by the first user, or the like.

### CROSS-REFERENCE TO RELATED APPLICATION

This application claims priority to U.S. Provisional Patent Application Ser. No. 61/895,260, titled “FOOD FEEDBACK INTERFACE SYSTEMS AND METHODS,” filed on Oct. 24, 2013, which is incorporated by reference herein in its entirety for all purposes.

### FIELD

This relates generally to creating and supporting a community for sharing information regarding food, and in one particular example, to an interface, process, and system for sharing images of food with other users or coaches to receive feedback and advice on food choices, and crowd sourcing food choices.

### BACKGROUND

The dietary industry and other major participants conventionally base nutrition or weight loss counseling on weekly in-person meetings, e.g., a person wishing to lose weight or receive nutrition advice meets with a trainer or coach to aid in his or her goals. It is desired to provide a more personal, real-time (e.g., at the time of eating) process for weight loss counseling.

### SUMMARY

According to one aspect of the present invention, an interface, computer-implemented process, and system are provided to facilitate a community for sharing food choices in an online social forum (e.g., in a crowd sourced feedback forum). In one example, a process includes receiving an image of food by a first user (e.g., from a user's smartphone camera), causing communication of the image of the food for delivery to devices of other users, and receiving comments from at least one other user based on the communicated image of the food. The comments may then be communicated back to the original user as feedback on the food. The images may be shared only with selected other users, e.g., coaches. One or more other users or “coaches” may be selected to receive a first user's images based on a user's profile, responses to questions, desires of the user, pre-selection by the first user, or the like.

In another aspect and example, an interface, process, and system includes a crowd sourcing model for feedback on a user's food choices. For example, a user may select a plurality of other users or coaches for receipt of images of their food choices. The images are then communicated to selected coaches, and the coaches may provide comments or other feedback to the user based thereon. Feedback from the coaches may be binary in form, e.g., restricted for review by the user and each coach individually (that is, other coaches associated with the user do not see feedback or comments communicated back to the user).

In another aspect and example, an interface, process, and system may include generating and causing the display of a weight tracker, which includes a user's weight over time with images of their food associated with time. For example, plotting weight over time and graphically tying, overlaying, or embedding images of the user's food along the time axis. Additionally, feedback from other users (e.g., coaches) may be displayed with the graph or images. This feature may allow a user to view the quality and/or quantity of their food choices over time and relative to their weight change.

Additionally, systems, electronic devices, graphical user interfaces, and non-transitory computer readable storage medium (the storage medium including programs and instructions for carrying out one or more processes described) for scoring political entities and providing various user interfaces are described.

### BRIEF DESCRIPTION OF THE DRAWINGS

The present application can be best understood by reference to the following description taken in conjunction with the accompanying drawing figures, in which like parts may be referred to by like numerals.

FIG. 1 illustrates an exemplary environment and system for carrying out various aspects of the present invention.

FIG. 2 illustrates an exemplary process for providing feedback on food choices.

FIGS. 3-22e illustrate exemplary screen shots and flows of the exemplary system and processes described herein.

FIG. 23 illustrates an exemplary computing system configured to perform any one of the above-described processes.

FIG. 24 illustrates an overview of various screenshots described herein.

### DETAILED DESCRIPTION

The following description is presented to enable a person of ordinary skill in the art to make and use the various embodiments. Descriptions of specific devices, techniques, and applications are provided only as examples. Various modifications to the examples described herein will be readily apparent to those of ordinary skill in the art, and the general principles defined herein may be applied to other examples and applications without departing from the spirit and scope of the present technology. Thus, the disclosed technology is not intended to be limited to the examples described herein and shown, but is to be accorded the scope consistent with the claims.

This relates generally to creating and supporting a community (which may include both professional and non-professional crowd sourced users) for sharing information regarding food, and receiving feedback and advice on food choices from other users. In one example, a user can enroll with an application and take photos of their meals (e.g., enrolling and taking pictures with their smart phone). When enrolling or interacting with the application, the user can select or be matched with other users and/or coaches selected for receiving images of food, and providing comments and feedback to the user. The user may also receive images of food from other users and provide feedback thereon.

The exemplary system is generally referred to herein as a Food Feedback (FFB) application or system, which is generally an application, interface, process, and system developed to create a community for sharing images of food choices. FFB generally targets users interested in improving their diet and/or nutrition, users interested in sharing food photos demonstrating their culinary creations, improving their culinary skills, and photos of meals they have while out at restaurants or otherwise eating away from home (e.g., “foodies”), communities of users with similar interests (e.g., fitness orientated people who see food as fuel, or users who have specific eating requirements, or cooking interests), and the like.

Users may further want professional coaching for improving their diet and/or changing their weight (loss or gain), combining their diet into their fitness training, learning or improving their cooking skills (which may include learning forms of specialized ethnic cooking, for example Italian, Indian, French). Users may also be interested in transitioning to other holistic approaches to eating, for example vegan, vegetarian, raw, gluten-free and other specialized forms of eating.

Users may further desire coaching around life/emotional issues, which often prevent people from optimizing their diet and health (for example, people are known to “comfort eat” when they are feeling unappreciated, lonely, or upset about current or previous events in their lives).

In contrast to conventional weight loss systems, and in one example, FFB uses crowd-sourcing for coaches, where the system allows users to have multiple coaches, and encourages users to share food photos as often as they have a meal. Having multiple coaches and/or sharing data relating to each meal may motivate users to improve diet and nutrition (rather than foodies who might only share when they have a meaningful meal to present). Further, much of the dietary industry encourages the use of pre-prepared meals, often frozen and full of preservatives, and other additives; in contrast, exemplary systems and processes described herein encourages the use of natural fresh ingredients, and creating meals at home.

Exemplary Architecture

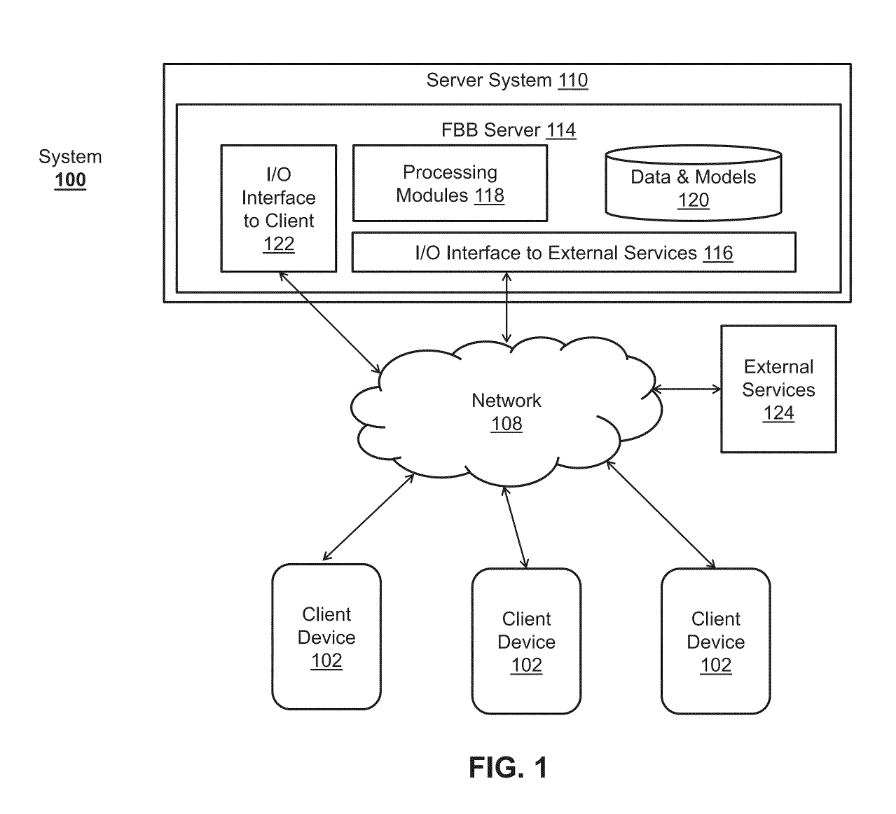

Initially, and with reference to FIG. 1, an exemplary environment and system in which certain aspects and examples of the systems and processes described herein may operate. As shown in FIG. 1, in some examples, the system can be implemented according to a client-server model. The system can include a client-side portion executed on a user device 102 and a server-side portion executed on a server system 110. User device 102 can include any electronic device, such as a desktop computer, laptop computer, tablet computer, PDA, mobile phone (e.g., smartphone), wearable electronic device (e.g., digital glasses, wristband, wristwatch, etc.), or the like.

User devices 102 can communicate with server system 110 through one or more networks 108, which can include the Internet, an intranet, or any other wired or wireless public or private network. The client-side portion of the exemplary system on user device 102 can provide client-side functionalities, such as user-facing input and output processing and communications with server system 110. Server system 110 can provide server-side functionalities for any number of clients residing on a respective user device 102. Further, server system 110 can include one or more FFB servers 114 that can include a client-facing I/O interface 122, one or more processing modules 118, data and model storage 120, and an I/O interface to external services 116. The client-facing I/O interface 122 can facilitate the client-facing input and output processing for FFB servers 114. The one or more processing modules 118 can include various issue and candidate scoring models as described herein. In some examples, FFB server 114 can communicate with external services 124, such as text databases, news feeds, subscriptions services, television programming services, streaming media services, and the like, through network(s) 108 for task completion or information acquisition. The I/O interface to external services 116 can facilitate such communications.

Server system 110 can be implemented on one or more standalone data processing devices or a distributed network of computers. In some examples, server system 110 can employ various virtual devices and/or services of third-party service providers (e.g., third-party cloud service providers) to provide the underlying computing resources and/or infrastructure resources of server system 110.

Although the functionality of the FFB server 114 is shown in FIG. 1 as including both a client-side portion and a server-side portion, in some examples, certain functions described herein (e.g., with respect to user interface features and graphical elements) can be implemented as a standalone application installed on a user device. In addition, the division of functionalities between the client and server portions of the system can vary in different examples. For instance, in some examples, the client executed on user device 102 can be a thin client that provides only user-facing input and output processing functions, and delegates all other functionalities of the system to a backend server.

It should be noted that server system 110 and clients 102 may further include any one of various types of computer devices, having, e.g., a processing unit, a memory (which may include logic or software for carrying out some or all of the functions described herein), and a communication interface, as well as other conventional computer components (e.g., input device, such as a keyboard/touch screen, and output device, such as display). Further, one or both of server system 110 and clients 102 generally includes logic (e.g., http web server logic) or is programmed to format data, accessed from local or remote databases or other sources of data and content. To this end, server system 110 may utilize various web data interface techniques such as Common Gateway Interface (CGI) protocol and associated applications (or “scripts”), Java® “servlets,” i.e., Java® applications running on server system 110, or the like to present information and receive input from clients 102. Server system 110, although described herein in the singular, may actually comprise plural computers, devices, databases, associated backend devices, and the like, communicating (wired and/or wireless) and cooperating to perform some or all of the functions described herein. Server system 110 may further include or communicate with account servers (e.g., email servers), mobile servers, media servers, and the like.

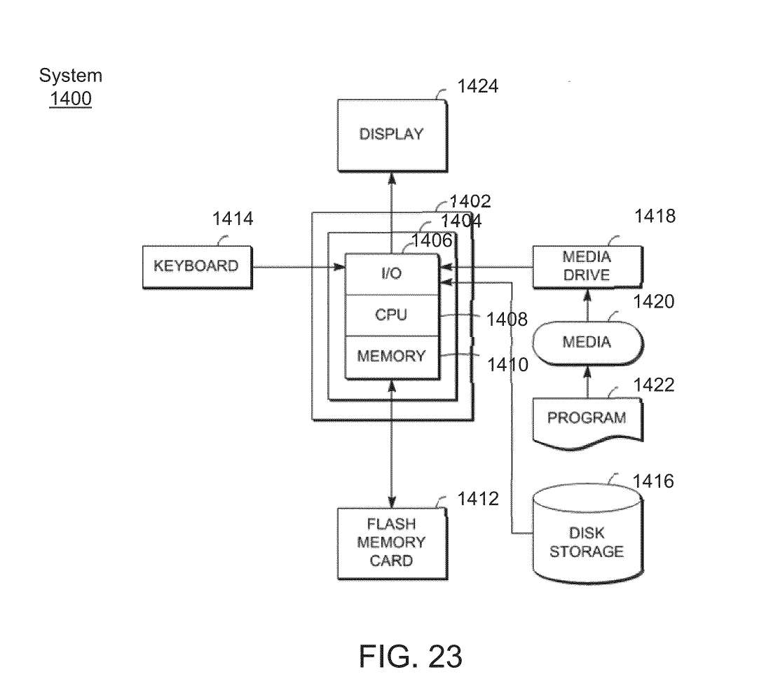

It should further be noted that although the exemplary methods and systems described herein describe use of a separate server and database systems for performing various functions, other embodiments could be implemented by storing the software or programming that operates to cause the described functions on a single device or any combination of multiple devices as a matter of design choice so long as the functionality described is performed. Similarly, the database system described can be implemented as a single database, a distributed database, a collection of distributed databases, a database with redundant online or offline backups or other redundancies, or the like, and can include a distributed database or storage network and associated processing intelligence. Although not depicted in the figures, server system 110 (and other servers and services described herein) generally include such art recognized components as are ordinarily found in server systems, including but not limited to processors, RAM, ROM, clocks, hardware drivers, associated storage, and the like (see, e.g., FIG. 23, discussed below). Further, the described functions and logic may be included in software, hardware, firmware, or combination thereof.

FBB Systems and Processes

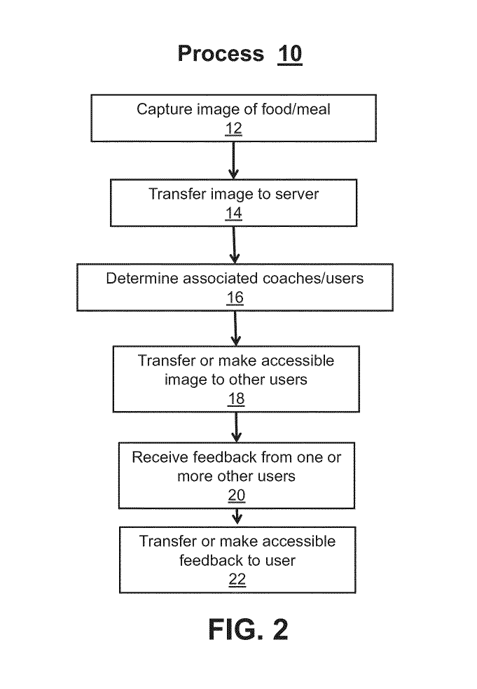

FIG. 2 illustrates an exemplary process 10 for capturing and sharing food images for feedback from other users and/or coaches. In one example, a user captures an image of their food at 12, e.g., before or during a meal. The image can be captured via an associated camera with a smartphone, and further the image may include a still image or video image. The image is then transferred to a remote server at 14, e.g., a FBB server (or server system) as illustrated in FIG. 1. The image data can be transferred with data relating to the user who took the photo, as well as related annotations, messages, and the like.

The process can further determine at 16 how to handle the image. For example, if the user has previously set-up to automatically share images with other users (e.g., coaches, friends, designated feeds), a server can transfer or make available the image to those users at 18. In other examples, the image data may be received with information relating to the desired access of the image, which may be used to make the image data accessible to certain other users (or not). In other examples, the image data may be made available to the other users, e.g., through an application interface.

The other users may then provide feedback on the images at 20. For example, users may make comments and suggestions, provide scores, approvals/disapprovals, image data, and the like. The feedback, in whatever form, may then be communicated back to the user at 22. As described in greater detail below, the feedback may be made by other users, selected coaches, and so on. Further, in some examples, only the originating user can view the feedback on his or her images, but in other examples, all users having access to the image can view associated feedback.

Exemplary Interfaces

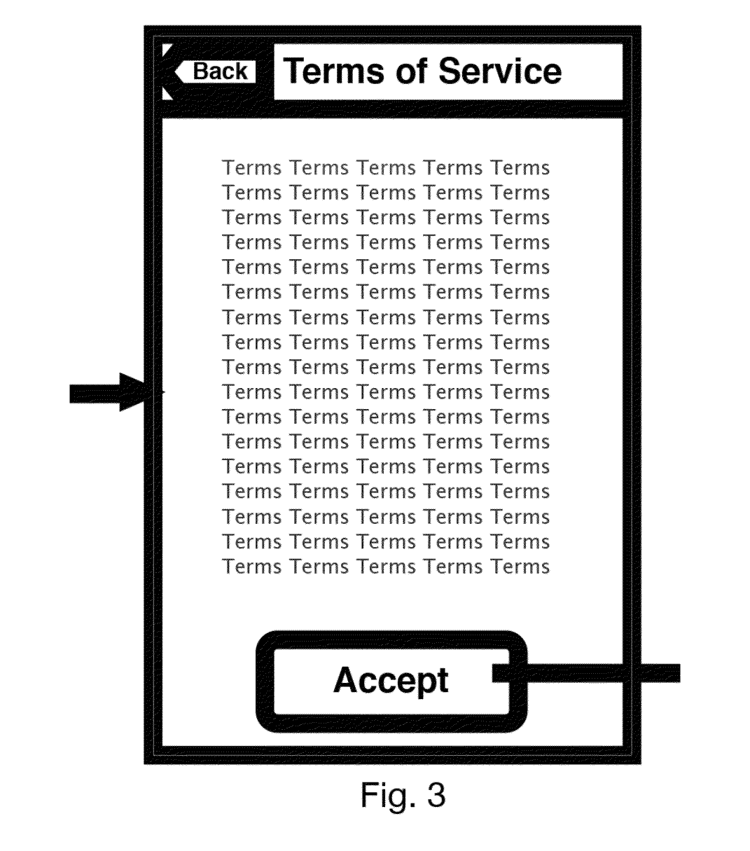

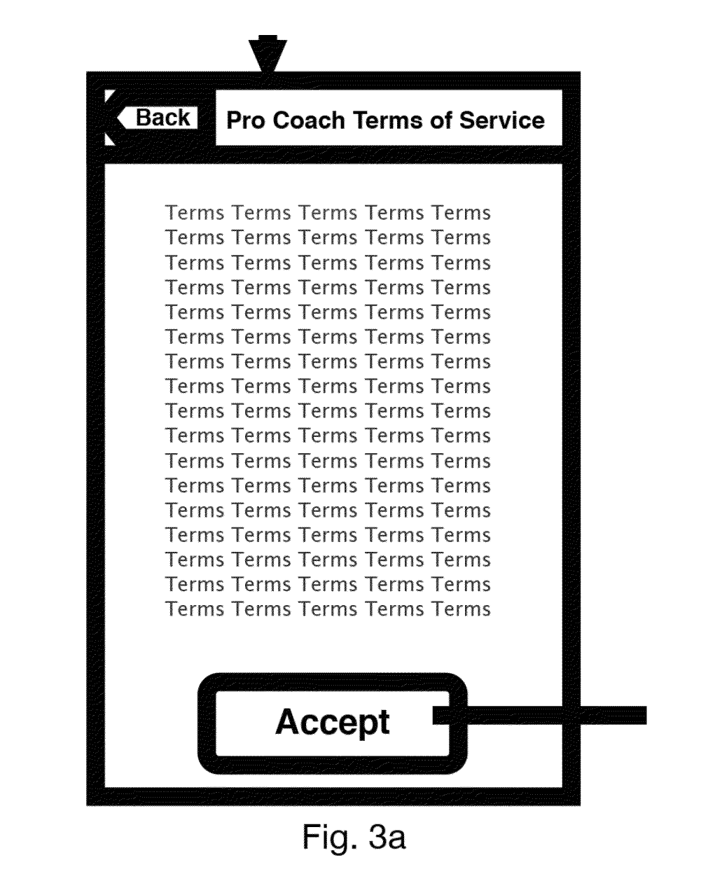

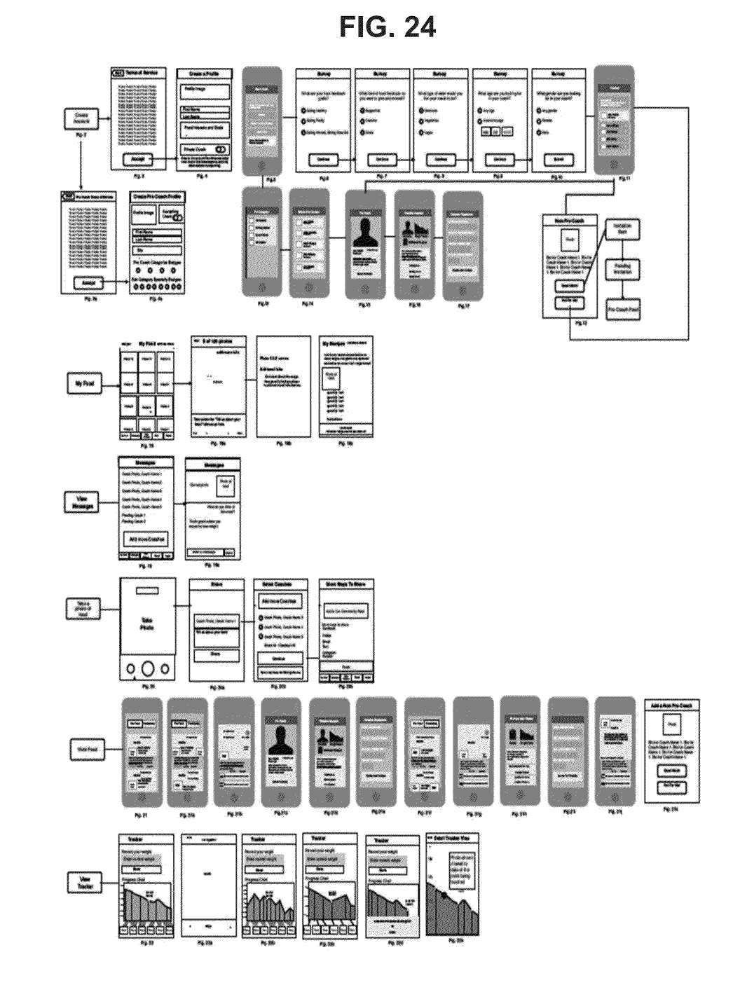

FIG. 24 illustrates an overview of various screenshots described below, as well as the general flow for a user navigating an application and interface according to one example provided herein. The exemplary overview begins with a user creating an account (in the upper left of the overview figure). User creates an account and accepts terms of service as illustrated in FIG. 3 (or otherwise logins, e.g., via Facebook or another social or connected application).

User Profile

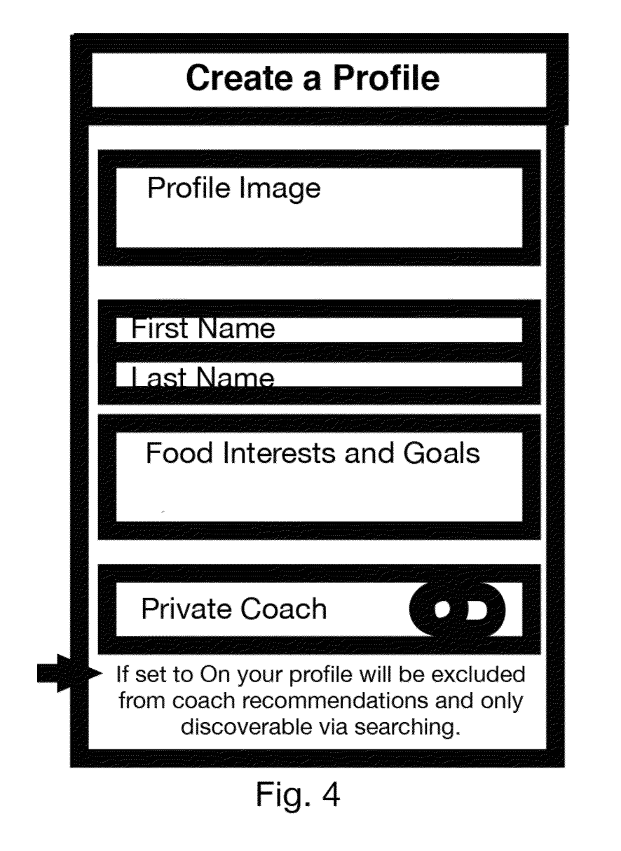

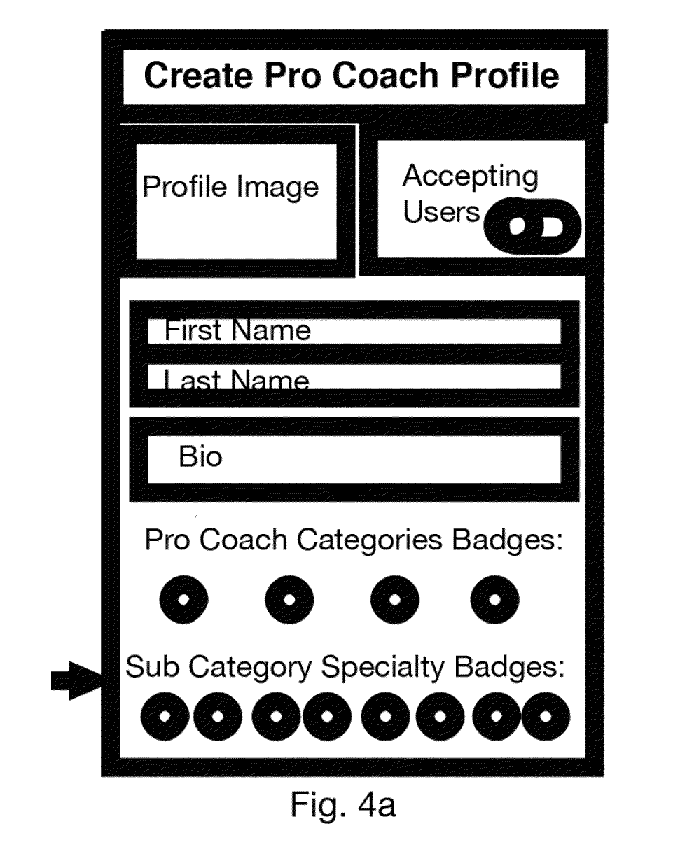

In one example, as seen in FIG. 4, a user engaging the application for the first time is asked to create a profile, which may include submitting a profile photo (e.g., from their mobile phone camera roll), entering his or her name, and creating a short indicated interest, e.g., shown here as Food Interests and Goals, describing their food interests and challenges. Users may update their profile later in time. Generally, and in one example, the profile photo, first name, last name, and biographical information are searchable by other users. Additionally, in some examples, every user is by default eligible as a “coach,” which will be described in greater detail below. Users can have the ability to only be identified as a Coach specifically by name (See Public Profile tab)

Pro-Coach Profile

In one example, the FBB systems allows for a range of professional coaches. Similar to above, when creating a profile as shown in FIG. 4A, professional coaches are asked to submit a profile photo either from their mobile phone camera roll, or directly by taking a photo on their phone, enter their names, and create a short section describing their specialties and background.

Generally, the profile photo, first name, last name, biographical section, and badges are searchable (except where the Pro-Coach may slide the toggle “Accepting Users” to an off position). Pro-Coaches may add badges representing the types of specialties they have. Each type of Pro-Coach category can be designated a standard badge, e.g., diet, cooking, sports, and life. Pro-Coach categories may also have sub-category badge selections. For example badges for certain types of cooking Pro-Coaches may be designated by country flag, or style, e.g., raw food, gluten free, or the like. For Sports Coaches, an unlimited selection of primary and niche sports and leisure activity type badges can be made available or entered.

Finding a Coach (Overview)

There are multiple ways to find a coach, including searching by name or by answering one or more questions to be matched with prospective coaches/provisional coaches, and by viewing both professional coaches and community posts and associated contributor profiles in the provided feeds. In one example, users can be matched with prospective coaches they do not know based on the user's indicated goals, personality, eating habits, age, gender, or the like. The FFB system can match from its database prospective coaches for a user to select from. The matching can be based on basic keywords, profile matching, or the like. For example, if a user wants someone who wants to eat healthy, gives direct feedback, and is a vegetarian they will be matched with the same. Various other matching algorithms are possible.

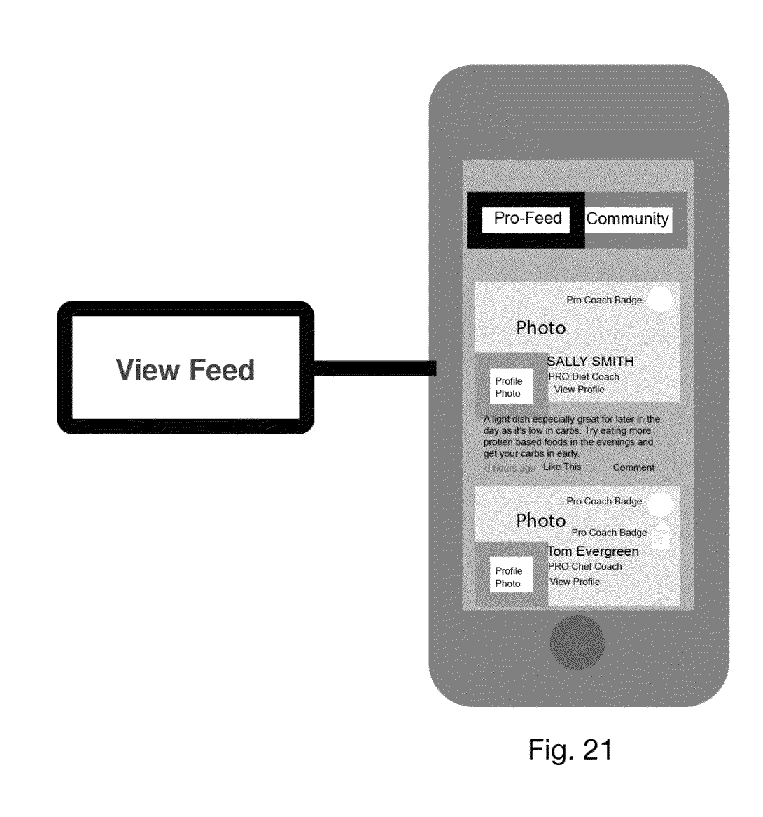

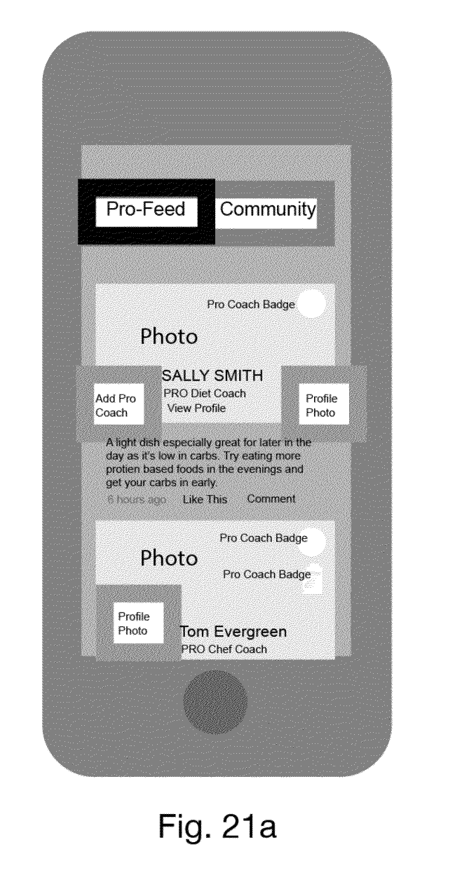

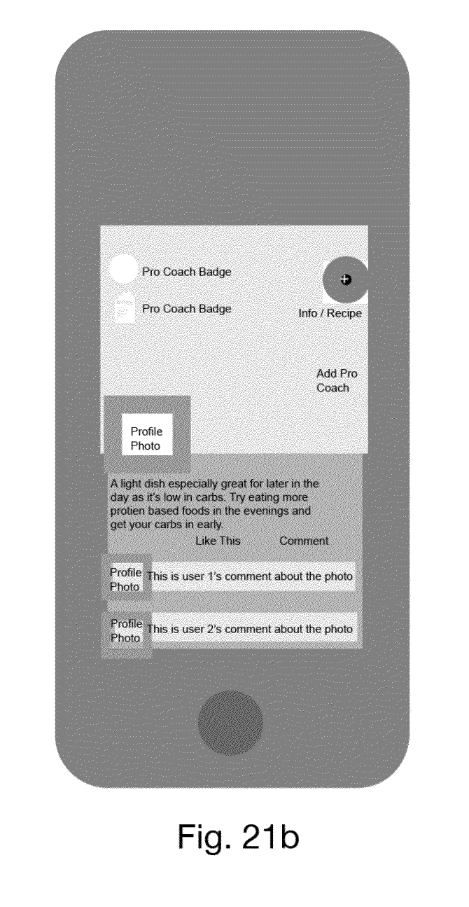

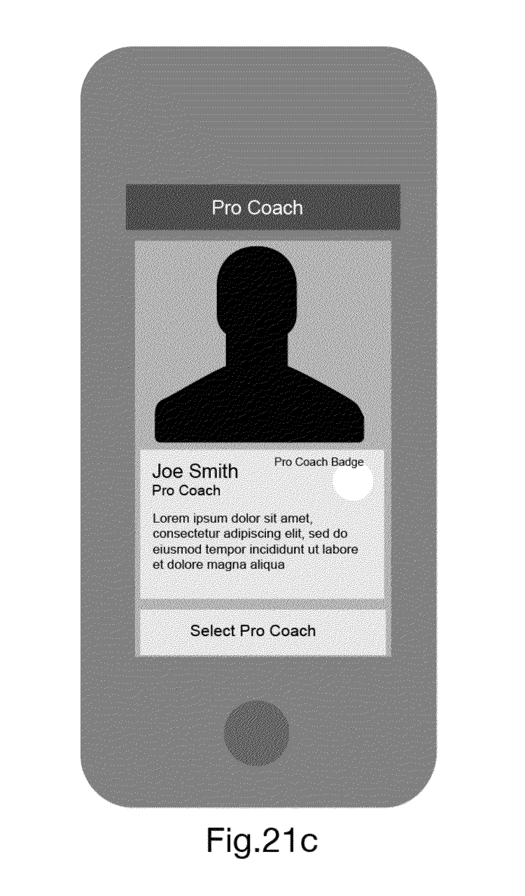

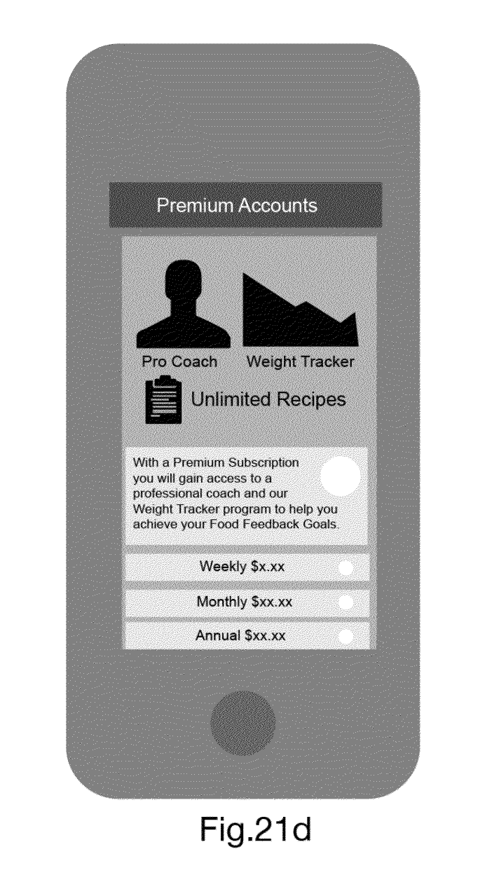

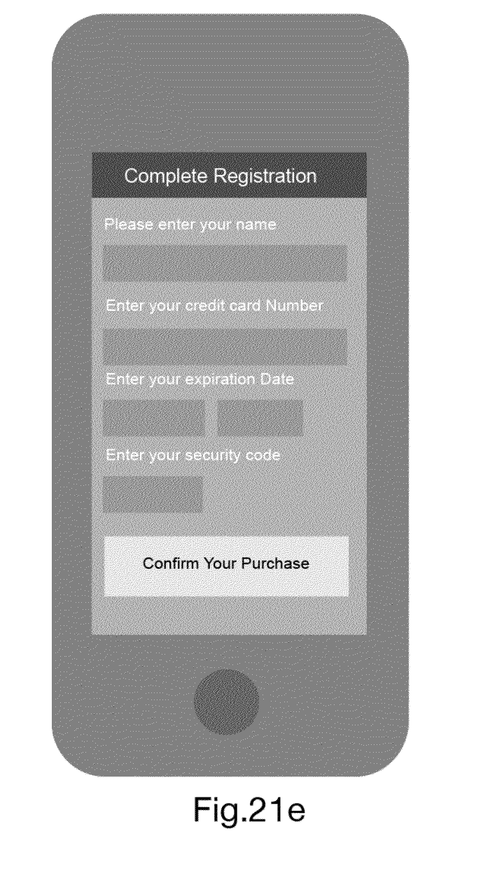

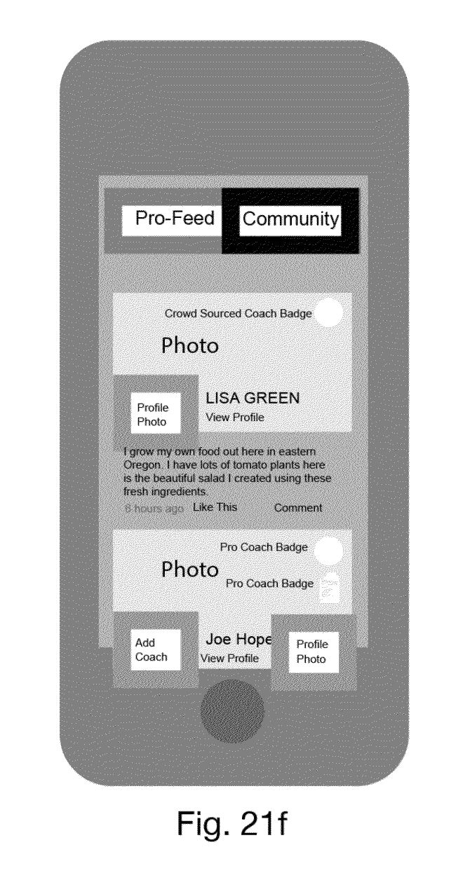

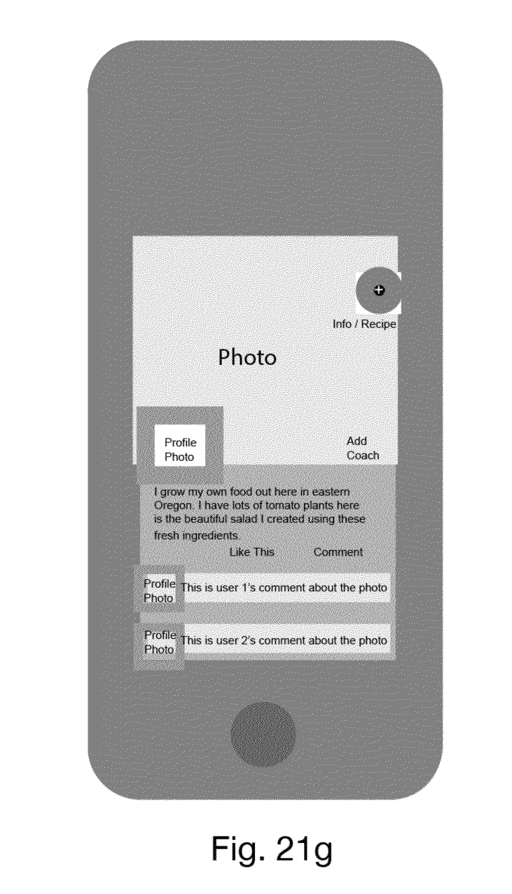

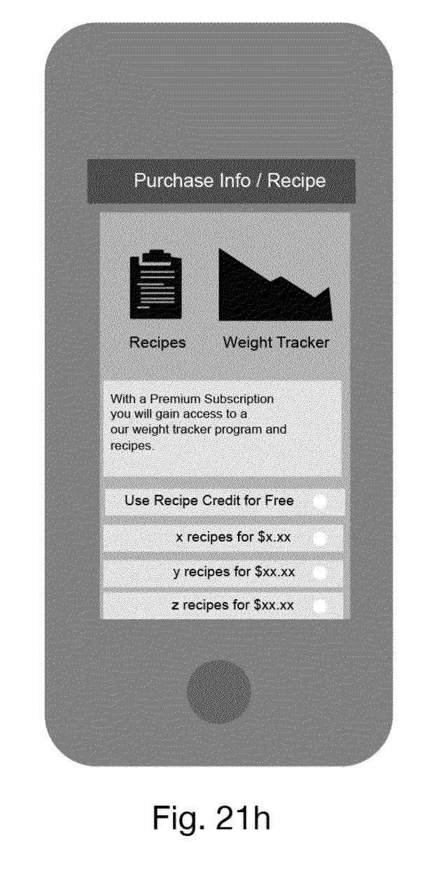

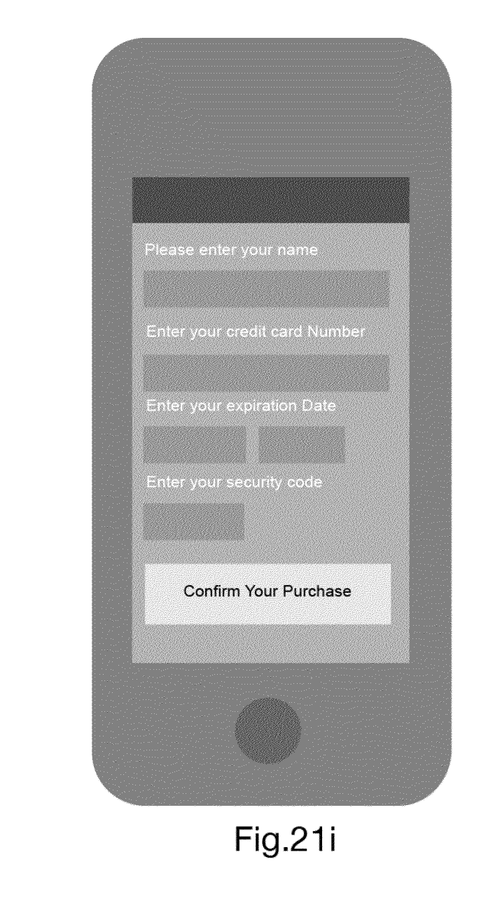

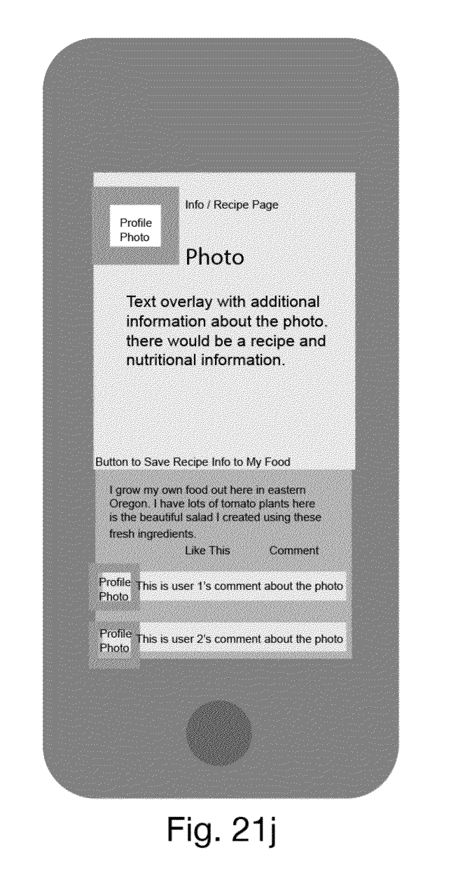

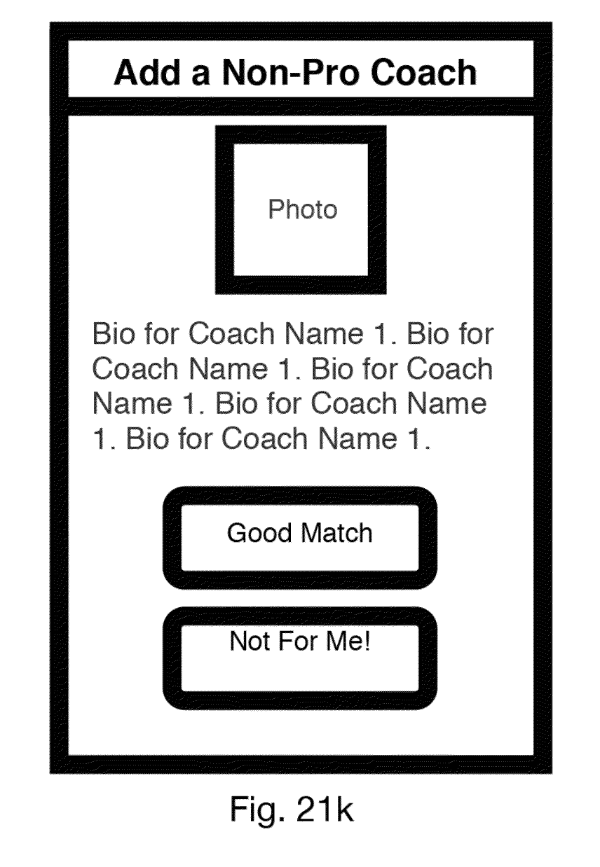

Users may also view food posts in the feed (from both Pro-Coaches, and the community). Each food photo has the profile photo of the user who is posting it such that if a user clicks the plus button in the profile photo, the user can initiate an invitation to the poster of the food photo (this is shown in FIGS. 21a and 21b). Of course, other selection and invitation processes are possible.

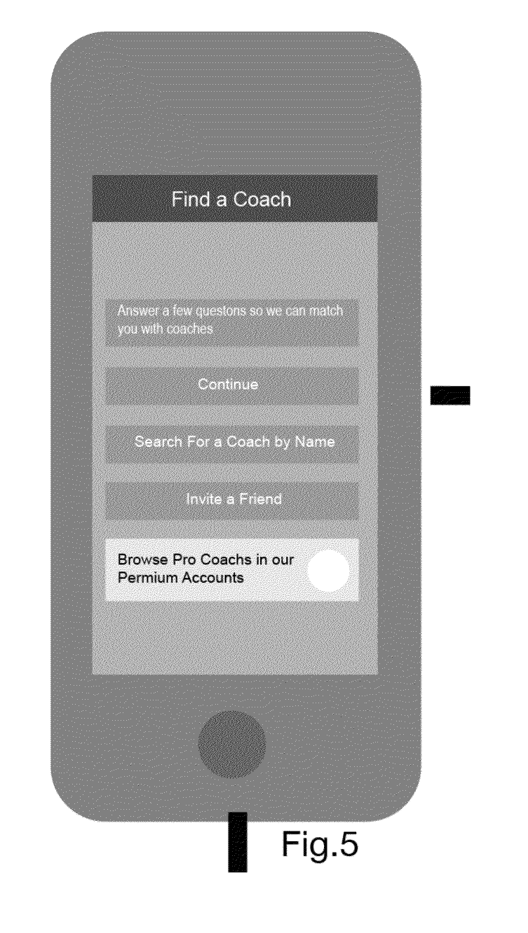

In one example, a user is asked a series of questions to help identify prospective coaches. For example, with respect to FIG. 5, users are prompted to “Answer a few questions so we can match you with coaches.” and are asked to either select:
Continue (to start the questionnaire); or
Search for coach by name (if this is selected user enters first name and last name), and which time a selection of coaches with the same first name and last name will be shown with profile photo, and this identical name, and is then able to select to review the coach profile to confirm whether this is the person a user is wishing to be coached by.

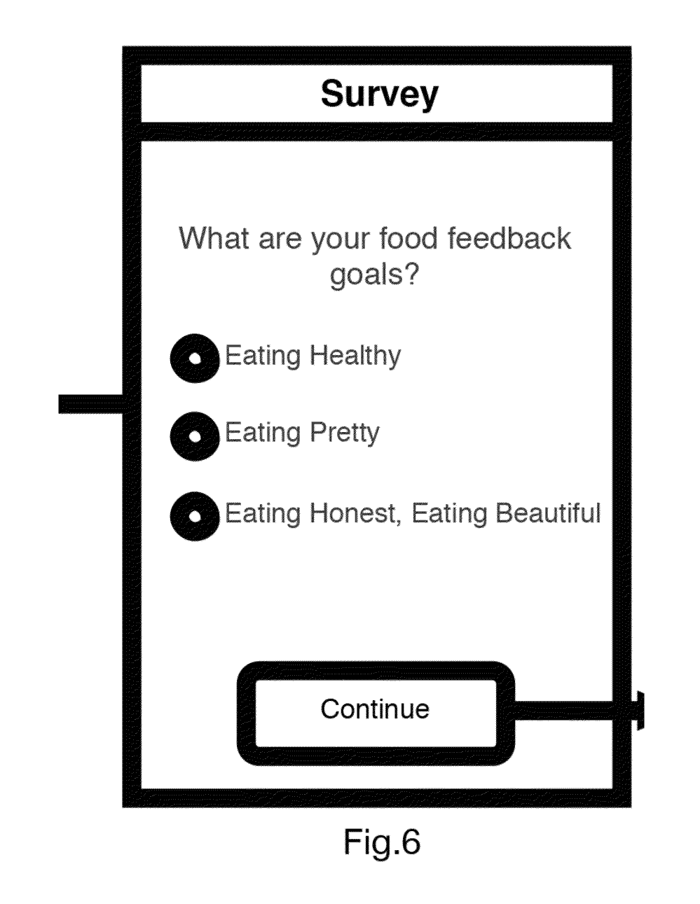

FIGS. 6-10 illustrate exemplary survey questions. For example, FIG. 6 asks the user to identify their goals from selections such as examples below:
Eating Healthy

I'd like to improve my diet and nutrition.
Eating Pretty I'd like to share my creations and learn new ones!
Eating Honest, Eating Beautiful I'm excited to do both.

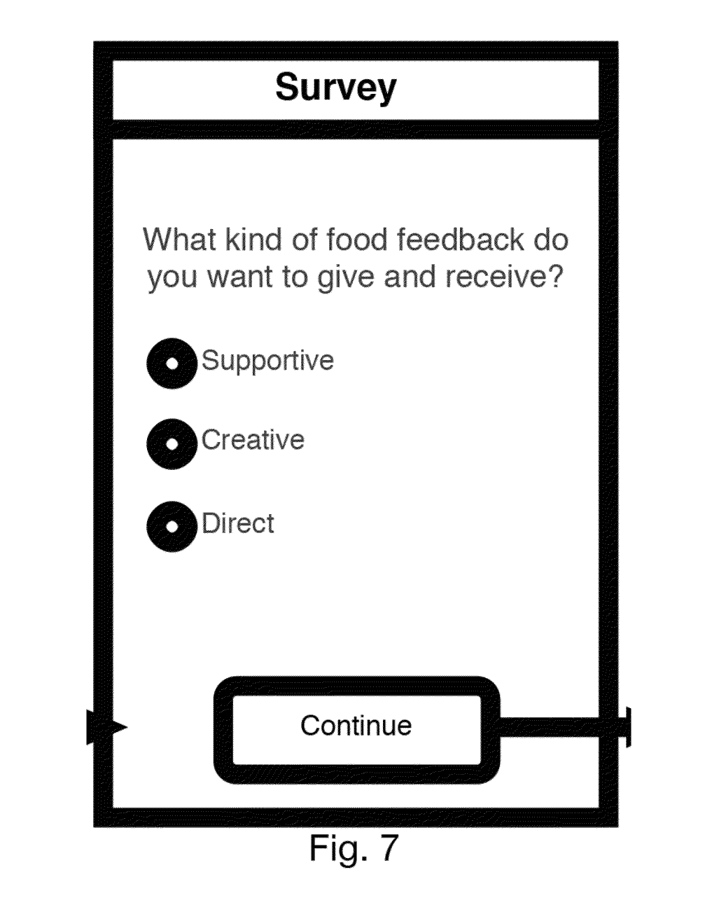

FIG. 7 asks users “What kind of Coach will you give and receive?” from selections such as the examples below:
Supportive

I need a cheerleader!
Creative

I'd like to share culinary ideas.
Direct

I'm looking for a coach to keep me on track.

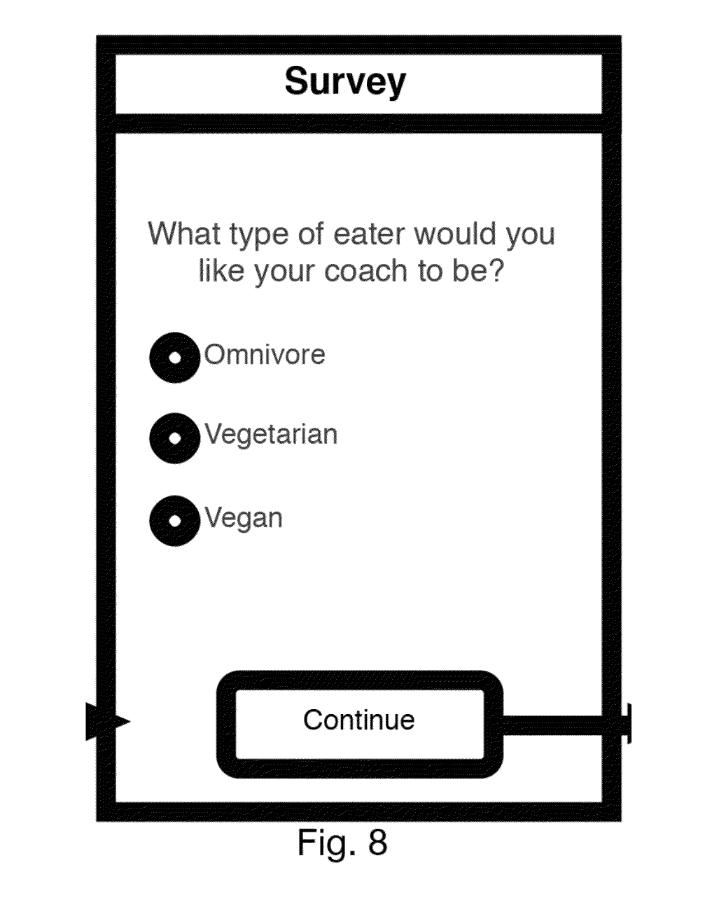

FIG. 8 asks users “What kind of eater would you like your coach to be?” from selections such as the examples below:
Omnivore
Vegetarian
Vegan

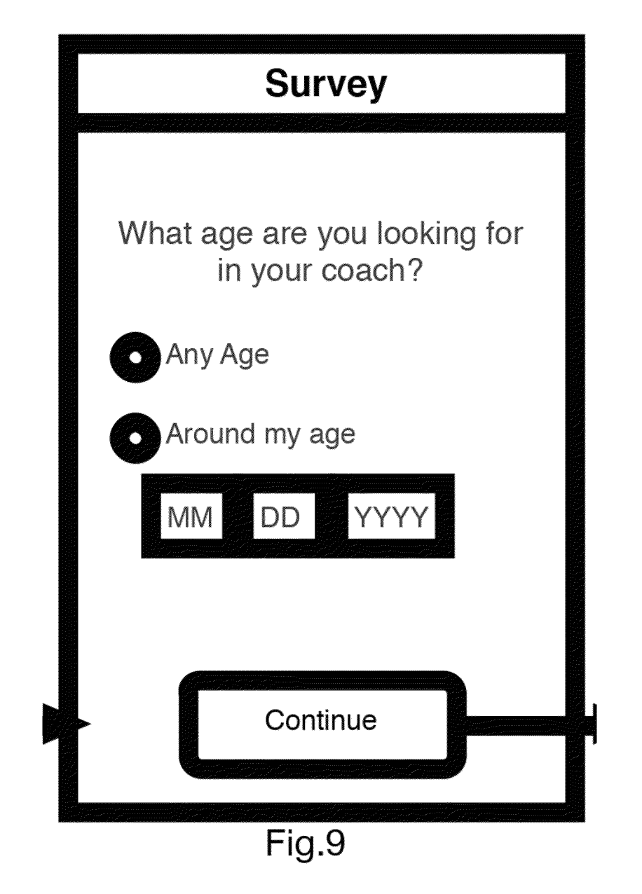

FIG. 9 asks users “What age are you looking for in your coach?” from selections such as the examples below:
Any Age
Around My Age
If Users select the second option a scrolling age dial will appear to enter User's month, day and year of birth.

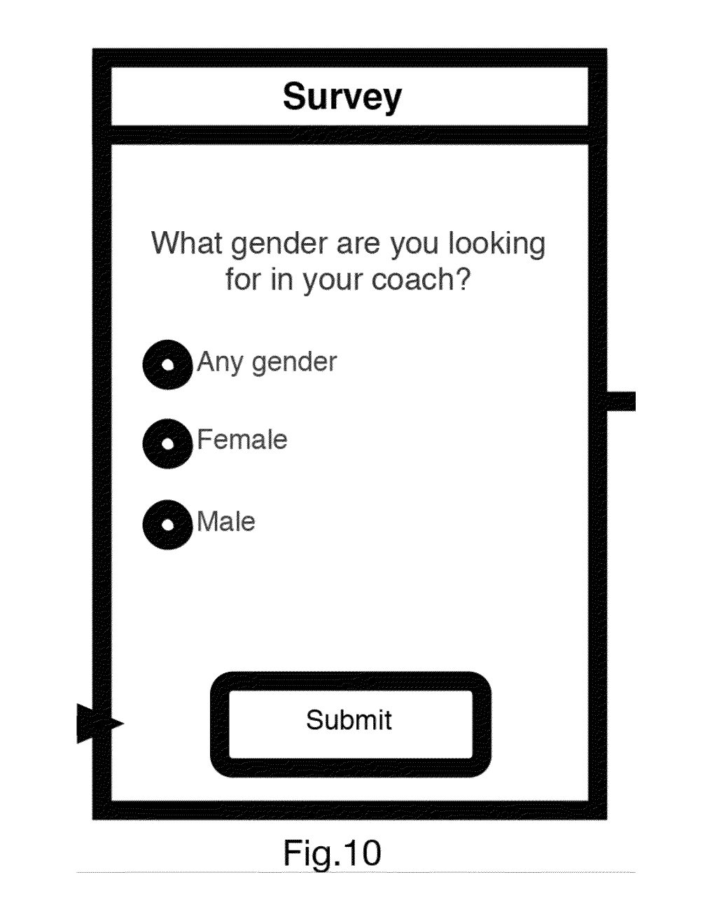

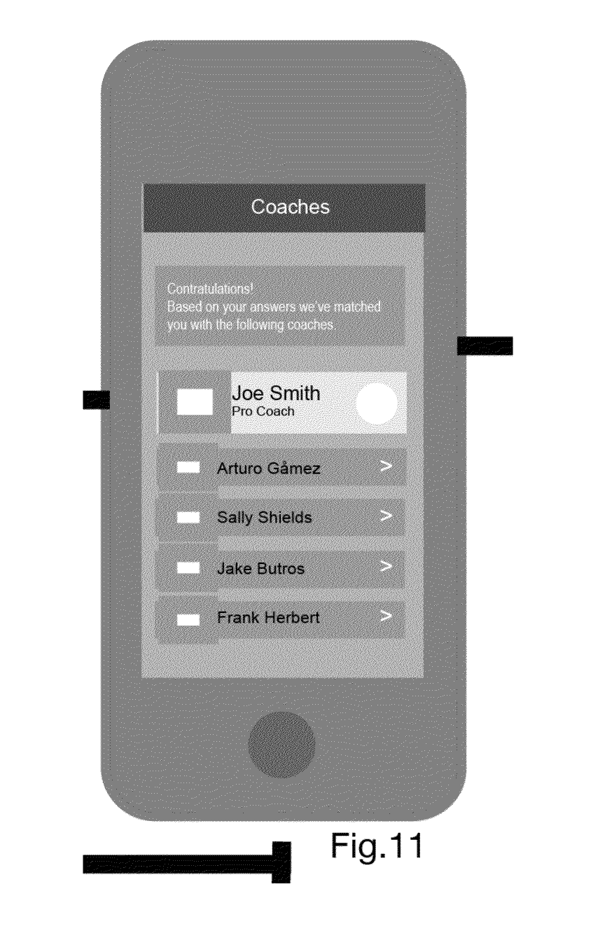

FIG. 10 asks users “What gender are you looking for in your coach?” from selections such as the examples below:
Any gender
Female
Male

In one example, the answers to these questions will not be accessible by other users (however, in other examples the answers could be available, e.g., searchable). Further, users may answer the questions differently each time they wish to select a coach, thereby having the flexibility to mix and match coaches with the objectives they are seeking to achieve (send a foodie a photo of a new creation or favorite recipe vs. another coach who may be helping them improve their overall nutrition).

Coaches

Once a user has been matched with one or more potential coaches, the interface can display a listing of coaches as illustrated in FIG. 11. In some examples, as many as ten potential coaches can be identified. The interface can further display a profile photo of the prospective coaches and their first and last names. Further, a notation can be included to view additional information on the coaches (or alternatively, a hover operation or selection by the user can be used to view additional information on the coach). The coaches may include both professional coaches as well as non-professional coaches, e.g., other users.

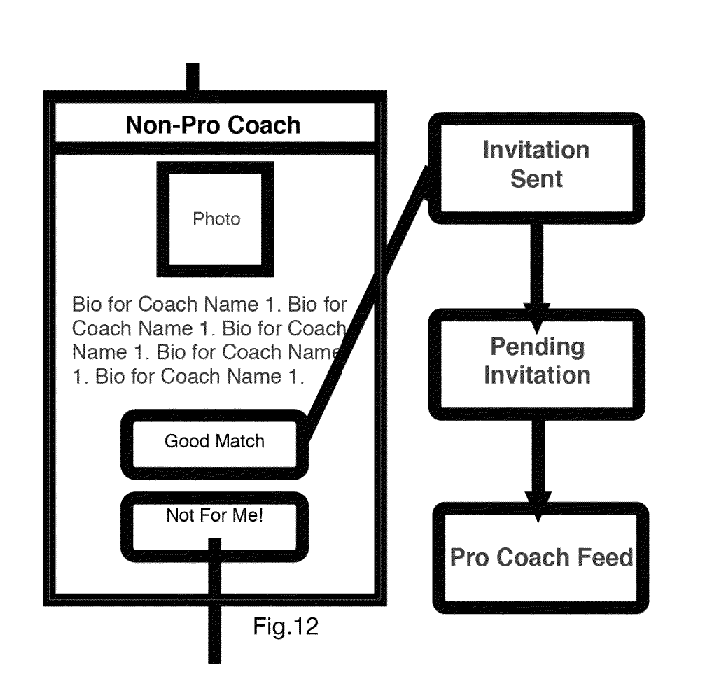

With respect to FIG. 12, a user can select a prospective coach, read the coach's profile, and then select as a “good match” or “not for me.” If a user approves or selects “good match,” the system may automatically send an invitation to the prospective coach to either accept or reject the invitation. If a user declines or selects “Not for Me,” the system can direct the user back to a listing of prospective coaches to keep looking for the right “match,” e.g., back to FIG. 11.

Pro Coach Categories and Selection Process

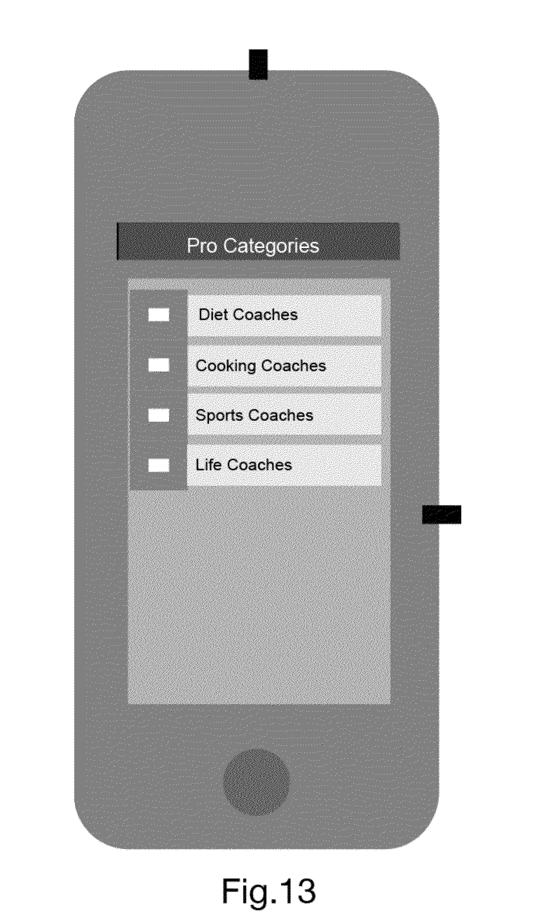

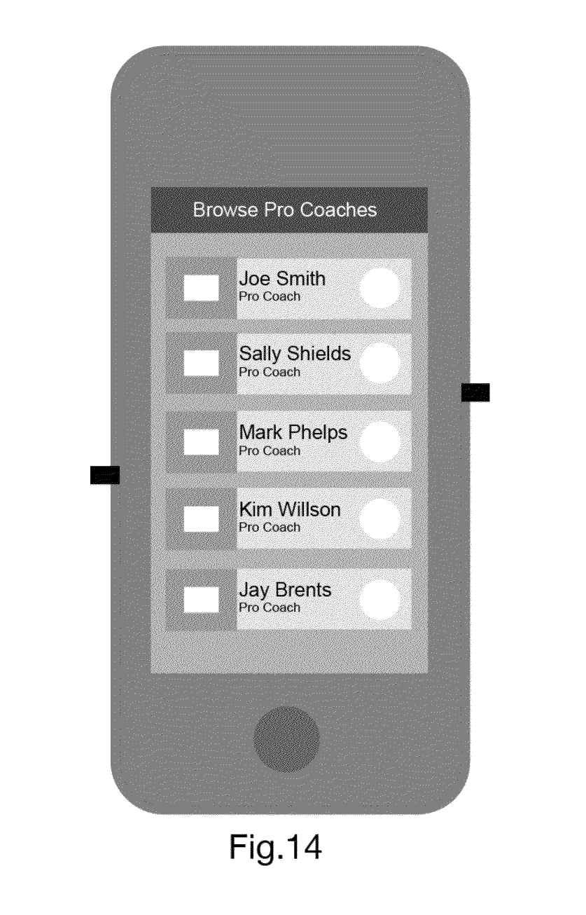

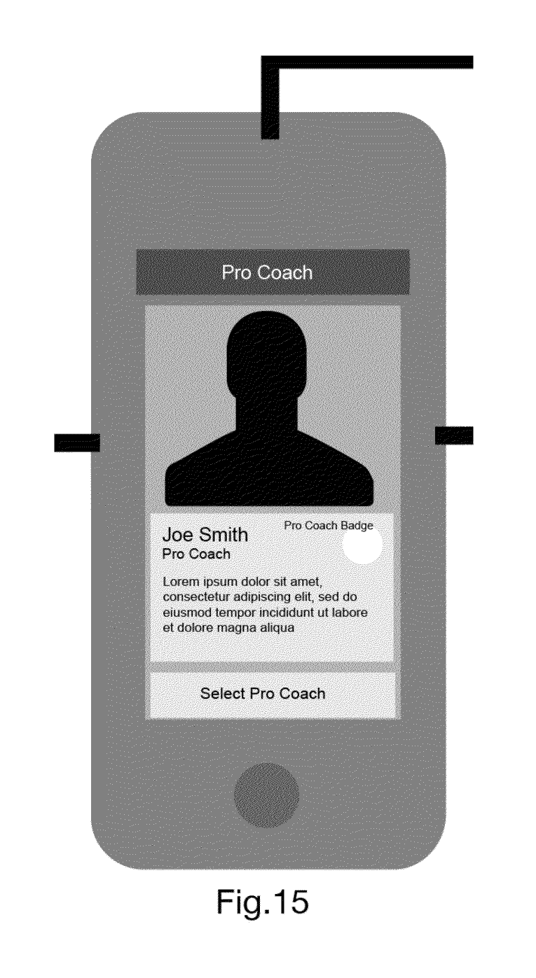

Users may have the ability to select from a range of different types of professional coaches. For example, different types might include “Diet Coaches,” “Cooking Coaches,” “Sports Coaches,” and so on as illustrated in FIG. 13. One a User selects a category, the user will be able to scroll down the list in the category and browse available Pro Coach profiles as illustrated in FIG. 14. In some examples, to aid selection of the best coach, badges designate areas of specialization that may be most appropriate for the user (e.g., based on previous answers or activity). Upon selection of a coach, a profile or additional detail on the coach can be displayed, e.g., as seen in FIG. 15.

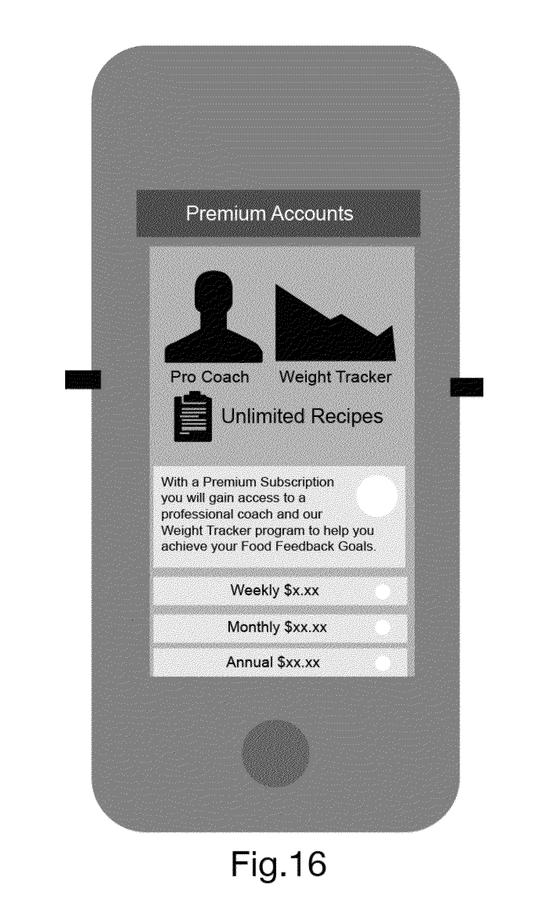

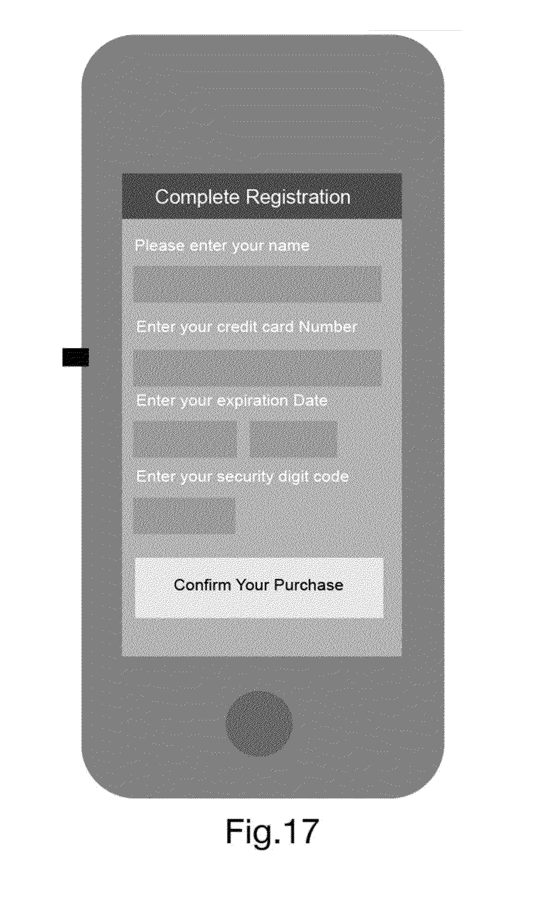

In some examples, the system may include a default version and a premium version. Accordingly, a user can be taken to a payments screen offering a premium service, as illustrated in FIG. 16, which allows for the user to receive coaching from the Pro-Coach and unlimited recipes, for example. Pricing options may be selectable for weekly, monthly and annual coaching with the selected Pro-Coach. The registration process can be complete at FIG. 17, with the input of additional information if not already received and confirmation of any purchases.

User Interface

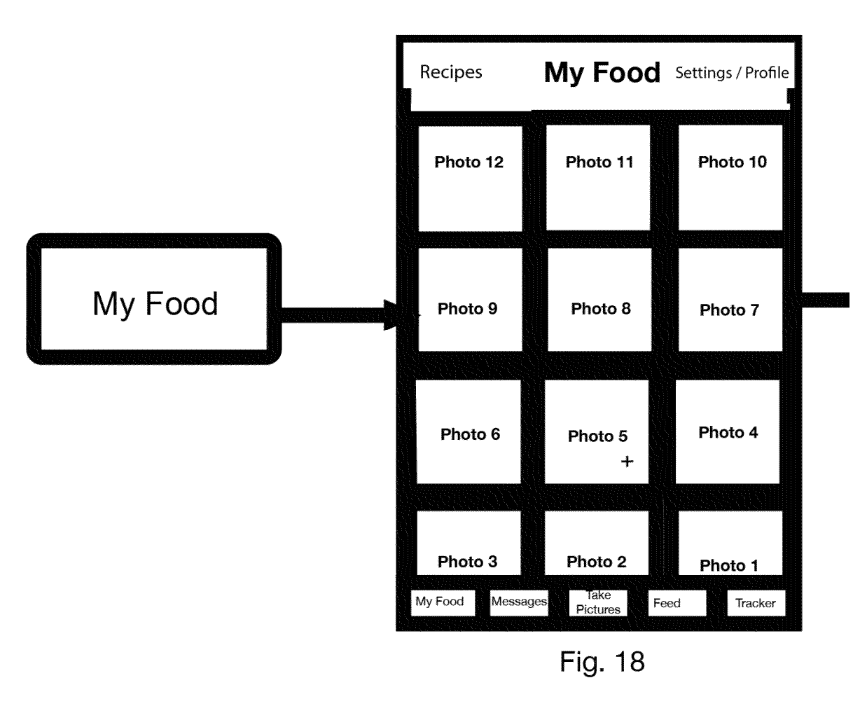

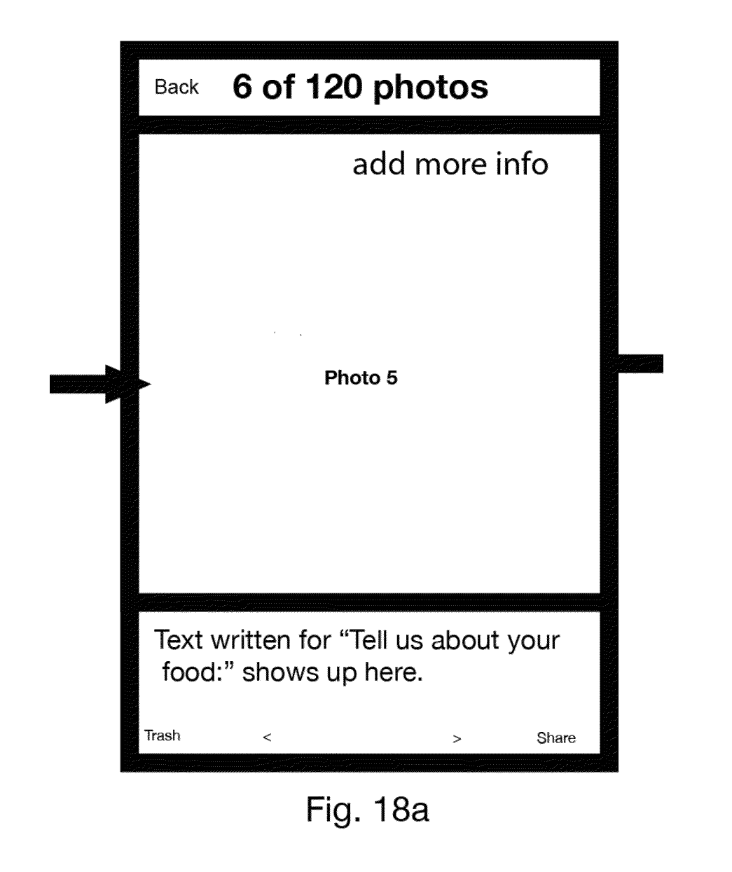

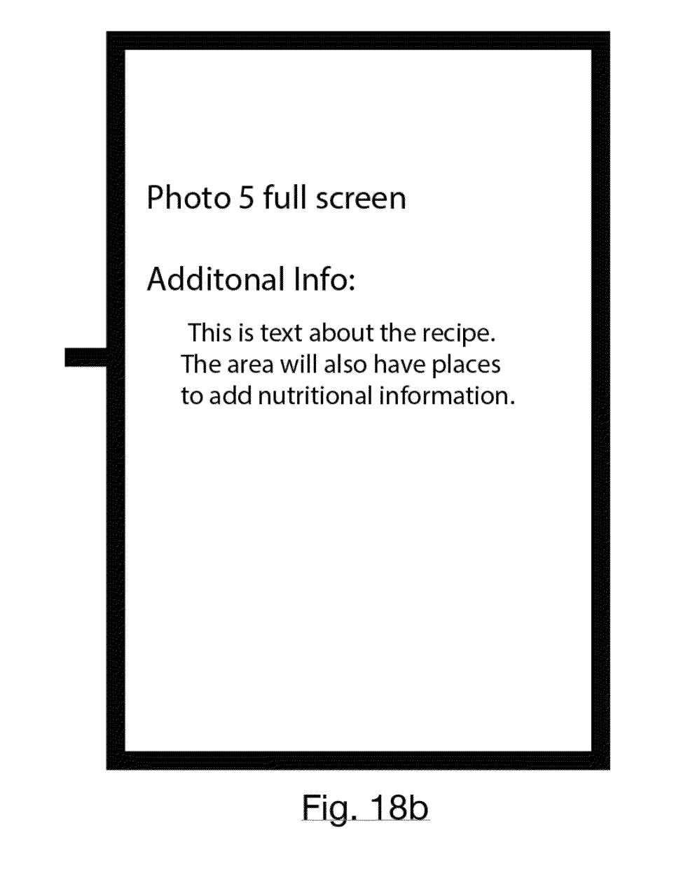

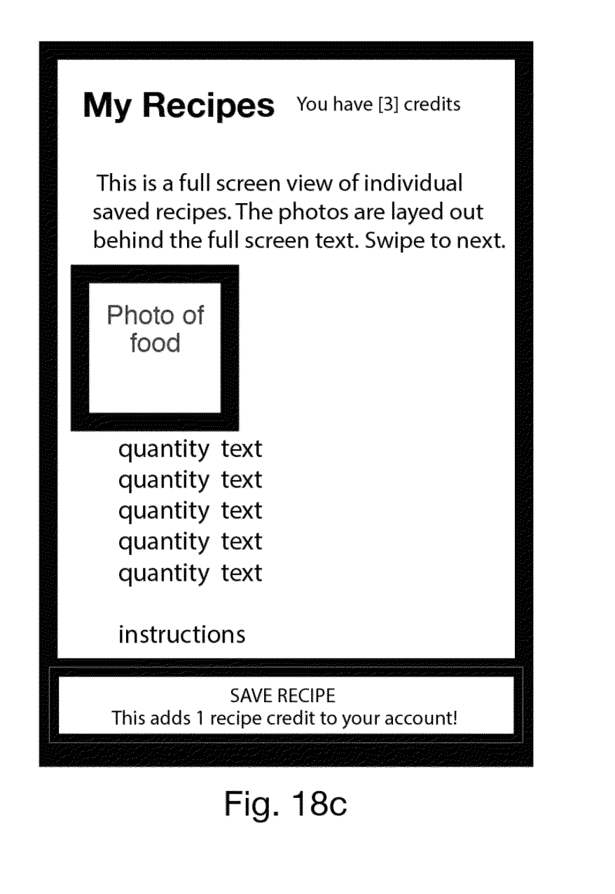

FIG. 18 illustrates an exemplary display panel, in this case illustrating a “My Food” panel displaying a gallery or food journal of the photos a user has taken in FFB. A photo may be created directly in the application, or taken from a smartphone camera roll. Users may select a photo by holding down on the photo to get a full screen shot. A user may then either: send it to another source; revert to the original page; or delete a photo by selecting the trash bin button.

FIG. 18a illustrates a selection of a photo, which may be annotated, e.g., describing a general text, recipe, a location, a restaurant, or the ingredients. Further selection of the photo or text can display more information as shown in FIG. 18b.

In another example, FIG. 18c illustrates a template showing a photo and providing the details of the recipe including both ingredients and instructions. In some examples, each time a recipe is shared, a crowd-sourced coach receives one recipe credit, which can be later used to trade recipes through FFB with other users. The total amount of recipe credits can be stored in settings or with a user profile, for example.

Messages

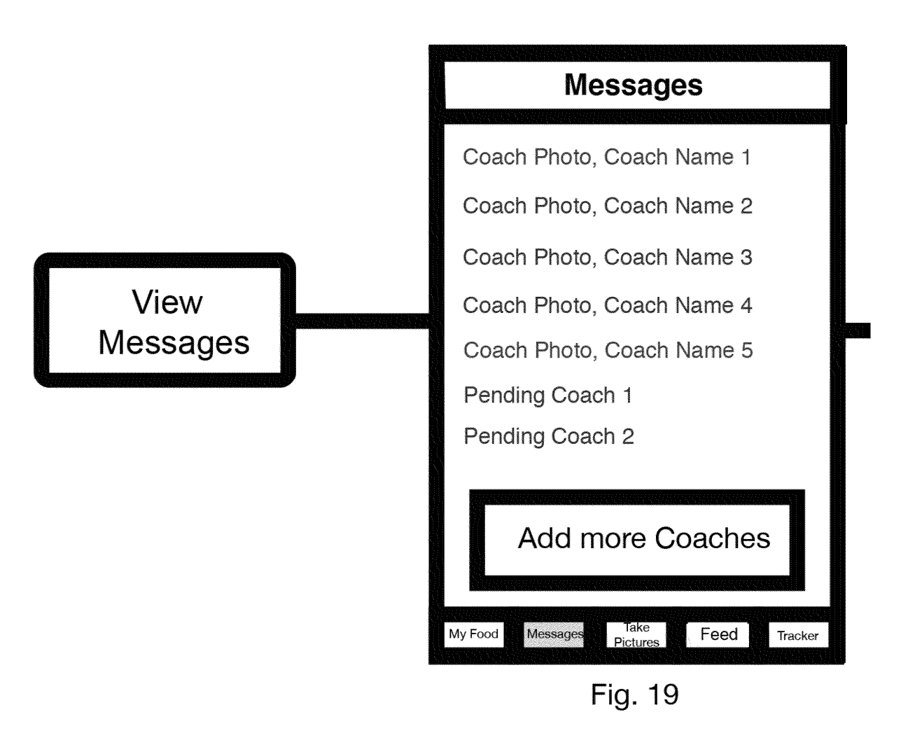

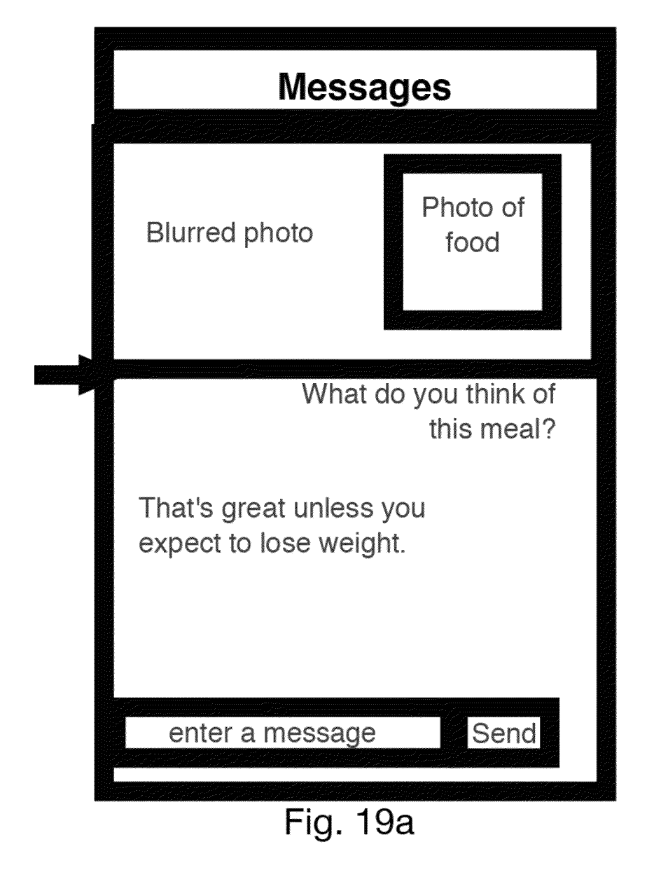

The messages tab or button, as shown selected in FIG. 19, allows a user to review the sharing of food photos and conversation between the user and a coach around a particular photo or series of photos. The main display can show a list of associated coaches, and the status of messages from each.

Further, in this example, uniquely and deliberately, if a food photo is shared with multiple coaches, the conversations remain binary (i.e., a coach will not see what another coach is saying about the food photo). This can be an important feature so that coaches do not pile onto a negative comment. In other examples, the conversation may be shared amongst multiple coaches.

In one example, shown in FIG. 19a, a user's food photos are shown both across the full width of the screen and as a close up on the right side. If a coach sends back any photos of their food, it can appear on the left hand side of the screen. In some examples, up to 20 photos can be viewed before a cache of earlier photos and messages is shown.

Below each photo sent is a text box where a user can send a message about the photo, and likewise a coach can respond. Further, in each message a small round condensed profile photo can be shown to make the conversation more intimate/personal.

Taking Photos

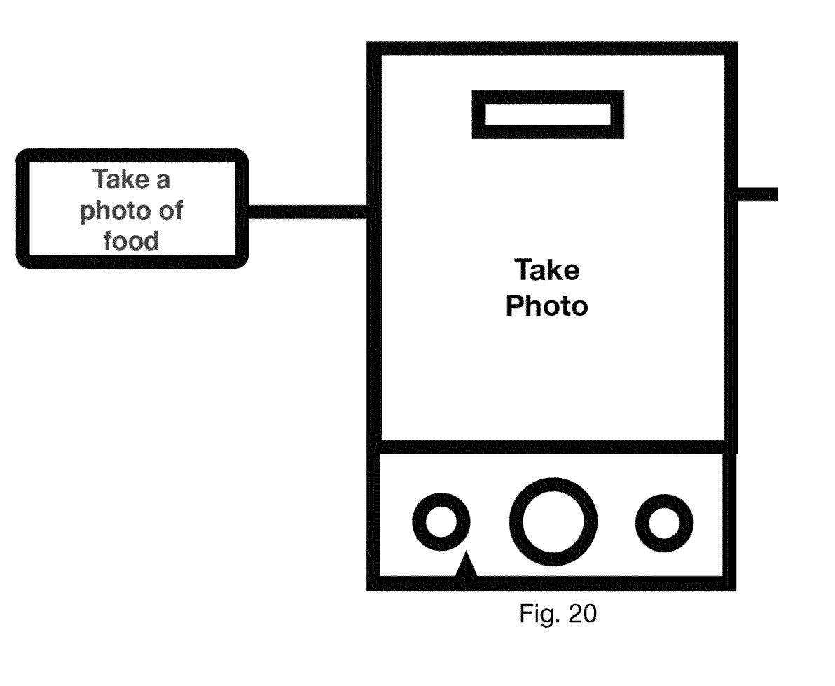

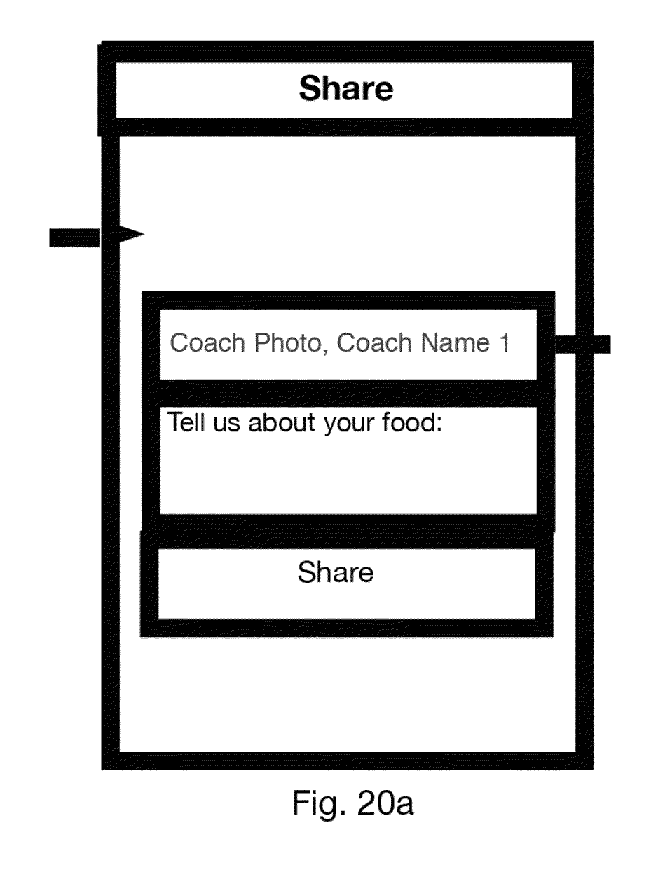

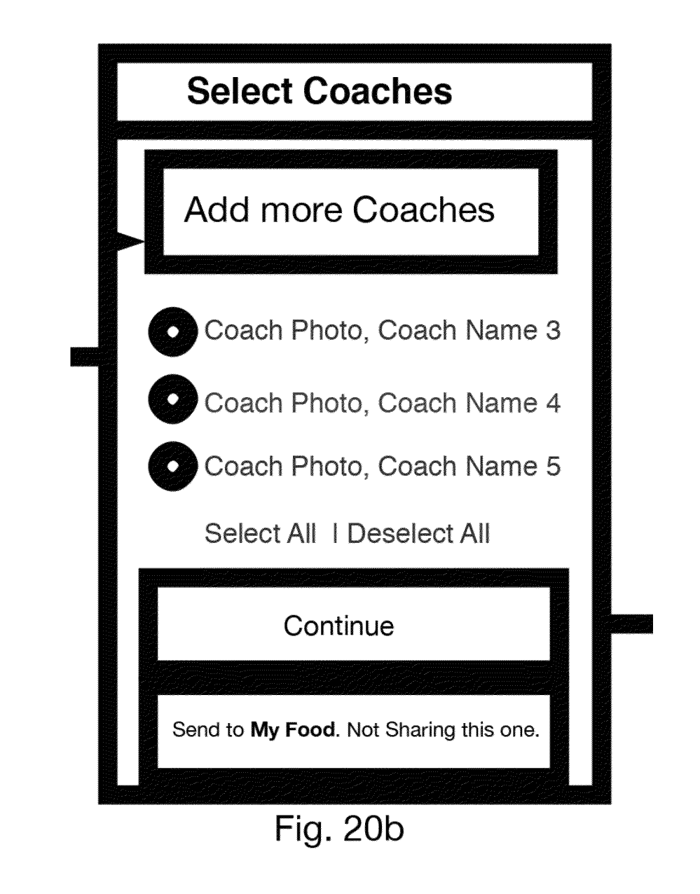

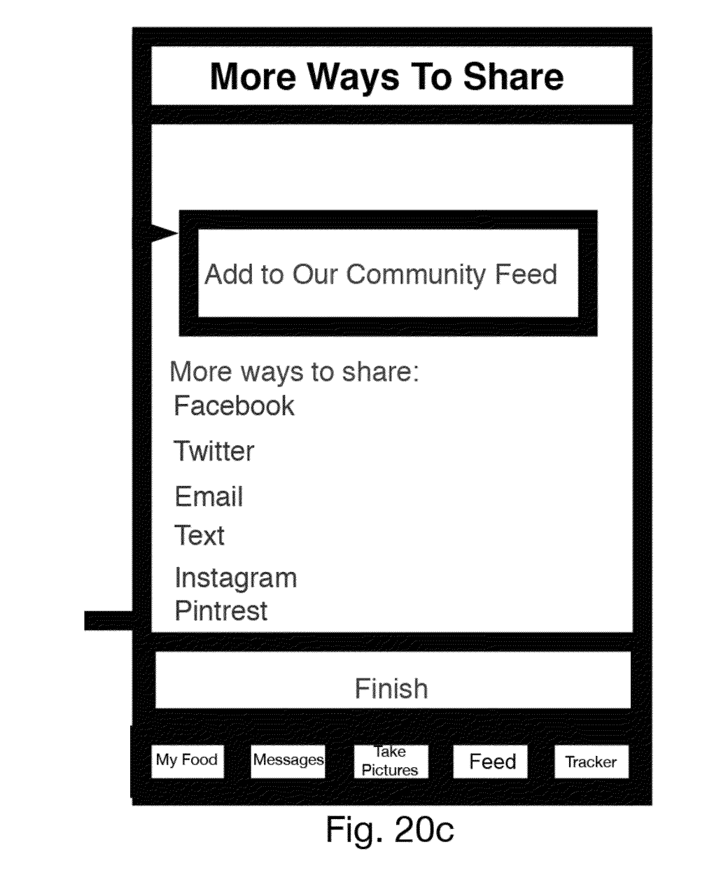

With reference to FIG. 20, upon selection of the Take Picture Tab (see FIG. 19) a take photo display can be presented to the user. In this example, the Take Picture Tab is centered on the bottom, but in other examples, the tab or functionally may be placed differently. Once a photo is taken, it can then be shared, deleted, or retaken. The photo can either be taken directly in the application or through selection in the camera roll option to the right of the camera.

A user then may select as many (or as few) coaches to send the photo to. Once selection is made, a text box can then be filled out (e.g., see FIG. 20a), and the selected photo can become a blurred image or background behind the text. Once a photo is selected, the user's list of coaches can be shown (with a photo to the left and name to right) (e.g., see FIG. 20b). In some examples, if the photo is not desirable to send to coaches but a user wishes to record the food eaten, then they may select an option at the bottom of the page “Send to My Food, Not Sharing this one!”

When a photo is sent to one or more coaches, the coach may receive the photo and/or message in one or more of the following ways, thereby alerting the coach of a new photo and/or message:
A crunch sound will be initiated on the receiving user's device, somewhat similar to a crunchy apple being bitten into. In other examples, a vibration or other audible or physical alert can be activated.
A coach can receive a message identifying who has sent a photo and/or message.
On the feedback application icon, e.g., on a smartphone main screen, on top right will be a number representing the number of unread messages
The main-page of the feedback application can show the same number of unread messages next to the message tab.

FIG. 20c illustrates a further interface which allows the user to share the images and/or messages. For instance, a user may select to share the photo more broadly with a FFB community feed or with other social networks, e.g., Facebook, Twitter, Instagram, and so on. Additionally, the user can share via other communication methods such as email, text message, and so on. Further, if any of the “More ways to Share this” are used the message can be sent with the FFB webpage and install linked for the application, e.g., a link for Apple App Store or Google Play.

Photo Feeds

FIG. 21 illustrates an exemplary photo feed displayed, which can be displayed in response to selection of the “Feed Button” in FIG. 19. The Feed generally allows the viewing of Pro-Coaches and other FFB featured participants' featured food photos. In one example, the feeds are separately selectable, but in other examples, may be included in the same feed.

With reference first to FIGS. 21a-21e, the Pro-Feed is described. In this example, users can select the Pro-Coach Profile Photo (bottom left of each post) and slide it open to see details of the coach, e.g., the bio and badges of a coach.

FIG. 21b illustrates an expanded view of the individual photos, which users may like or comment upon or press graphical marker for additional information for a recipe (see, e.g., FIG. 21j). In one example, in response to liking a photo the application can cause a notification such as a sound, e.g., a cork popping or apple crunching sound, which can also be displayed at the originating user's device. The user may be able to perform various actions on the photo to view, for example, the photo can be moved up and down within the image box. Double tapping the image can induce zooming. Single tapping the image expands the image to the full size of the screen. Tap once again after zooming and the image goes back to the original size.

FIG. 21c illustrates a detailed view of a Pro Coach, from which a user can select them to be their coach. Selection brings the user to a payment screen (FIG. 21d) for payment details and the like. Again, registration can be completed (if not already) and any purchase confirmed via an interface as shown in FIG. 21e.

FIGS. 21f-21k illustrate an exemplary community photo feed. Similarly to the Pro-Coach feed, users can see the scrolling list of posts from community (non-professional) coach users' photos. Users can select the community user profile photo (bottom left of each post) and slide it open to see the bio and to request the user become a coach (as shown in FIG. 21a).

Upon selection of an entry in the feed, users can see a detailed view of the post as illustrated in FIG. 21g. Users may like or comment on a photo. They can see a scroll to see comments from other users (which may include Pro-Coach impromptu feedback and the associated link to allow a user to purchase Pro-Coaching as described above). Users can add a crowd sourced coach (see FIG. 21k if a user decides not to invite prospective coach profile).

Further, in some examples, a recipe badge can be shown and selectable by the user. If a crowd-sourced coach's recipe is selected for purchase, the system can take the user through to a Premium Service Screen (e.g., FIG. 21h), where a user may either buy a recipe (which will then go to My Recipes in My Food) or alternatively trade their own recipe. Further, users can create credits if they post more recipes than they have received from other users, and then use these recipe credits at a later time. As described above, if purchasing a recipe the user can be taken through a payments and confirmation screen (FIGS. 21i and 21j).

Tracker

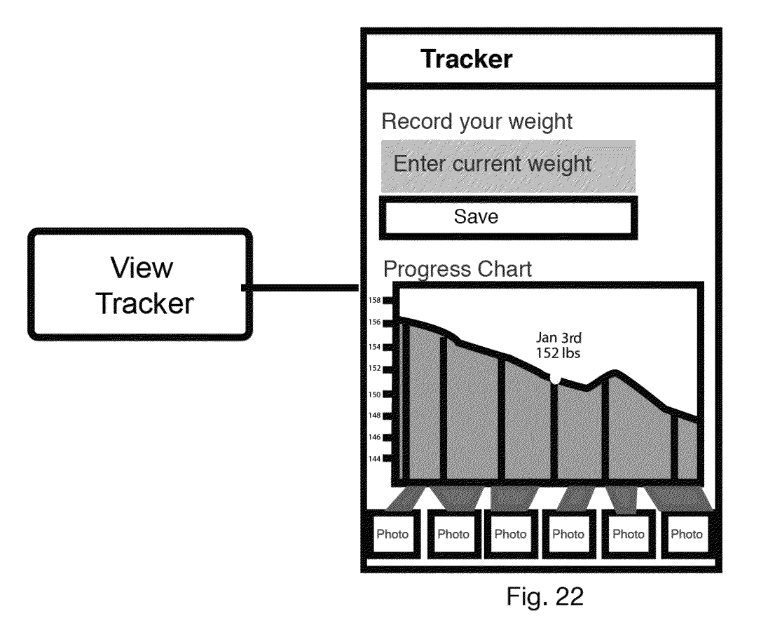

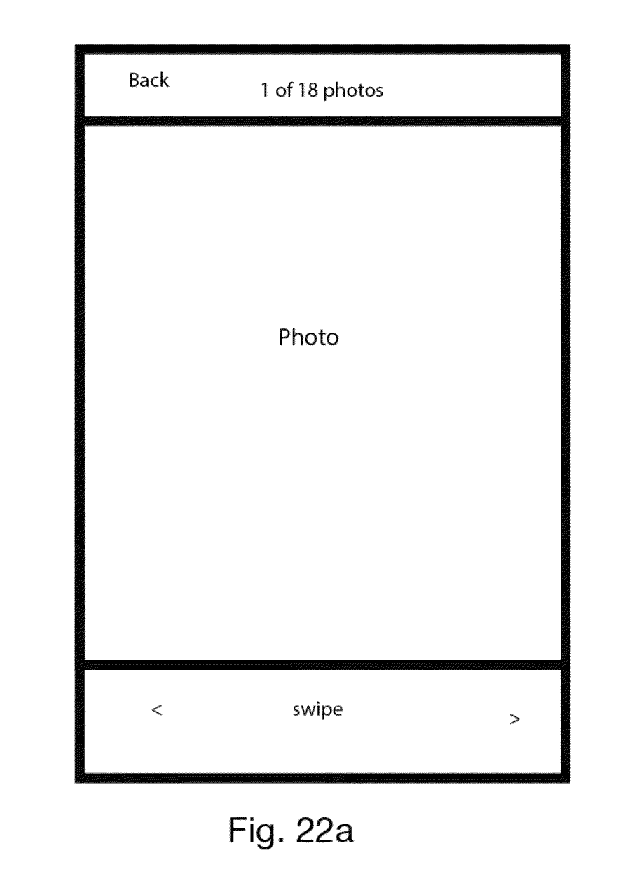

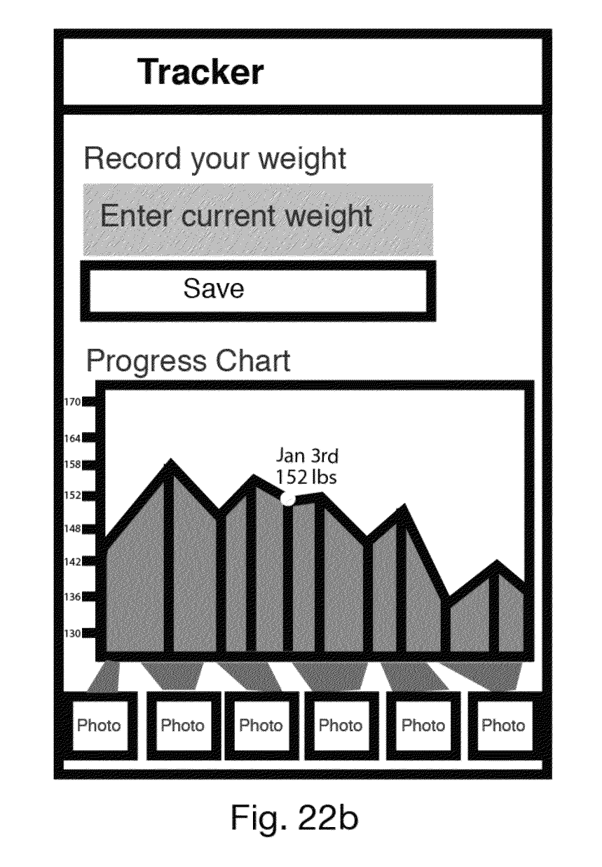

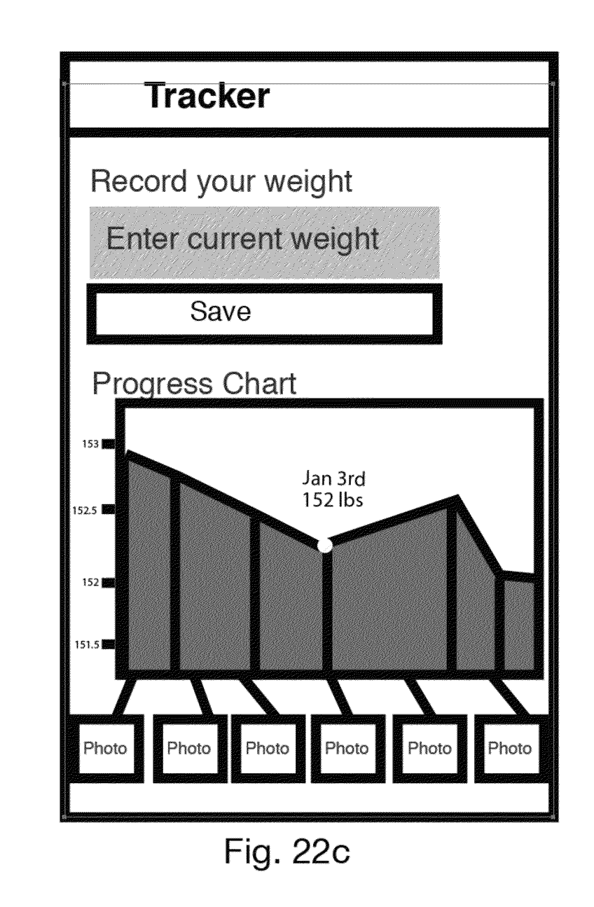

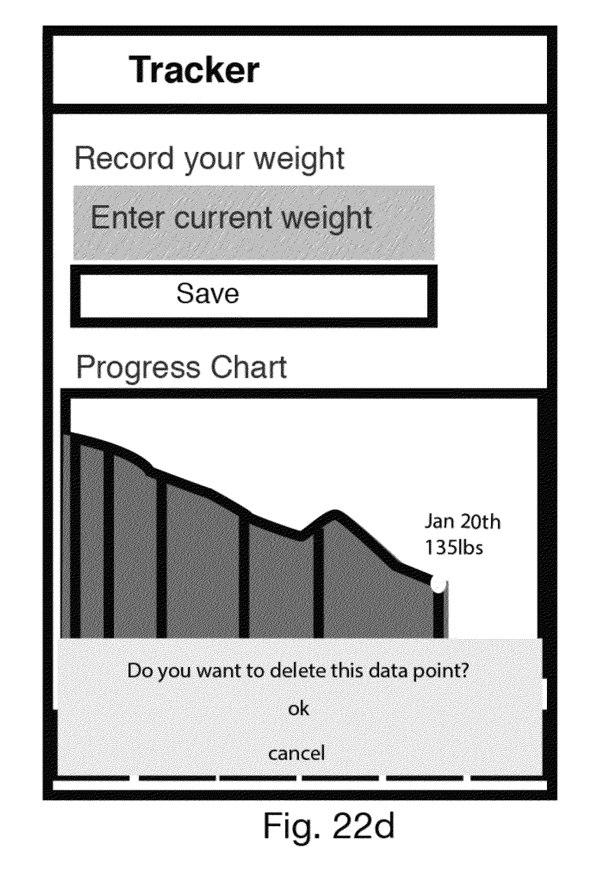

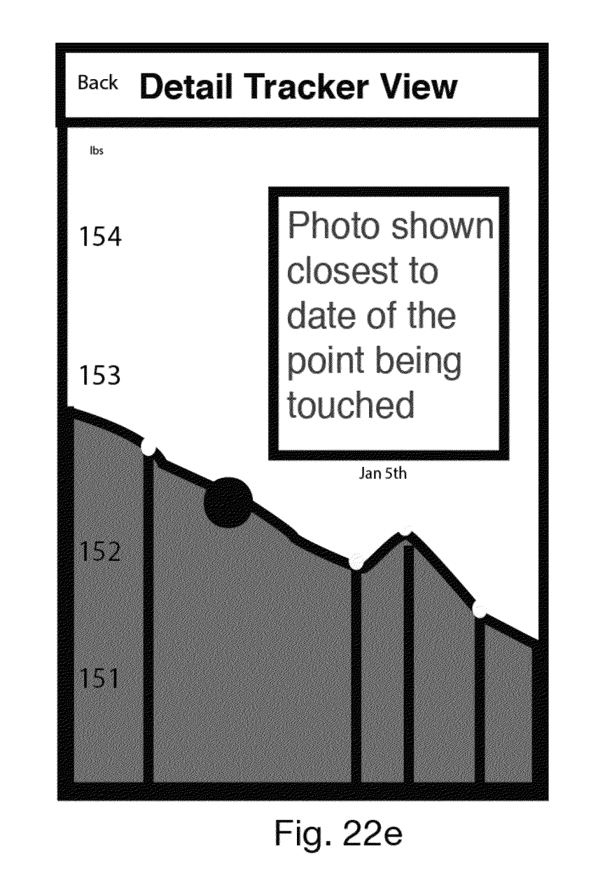

FIG. 22 illustrates an exemplary weight tracker, which may be used to track the user's weight over time and incorporate photos taken by the user with the timeline. For example, a user enters their weight, and may select from their preference of lbs. or kgs. In this example, weight is plotted on the y-axis, time on the x-axis.

Food photos from the application can be gathered between weigh in time intervals on the x-axis, e.g., every day, weekly, bi-weekly, monthly, etc. From this, each photo can be tied to or otherwise associated with the timeline and displayed or viewable. In other examples, a representative photo can be displayed for each time period, e.g., a randomly selected photo, most commented or shared photo, or the like. Further, in one example, a user may zoom in or out of the weight tracker and view a subset of available food images, e.g., five images, spread across the scaled time frame.

The tracker allows users to see how the quality and quantity of food consumed contributes to the results of their weight (both positively and negatively) reinforcing good habits and helping users become more self-aware of their actions when eating less desirable foods.

FIG. 22a illustrates that by selecting (tapping) the first photo in any photo batch (shown on the screen of FIG. 22), the user can then swipe photo by photo (represented by screen) across the relevant batch of food photos. The batches are not necessarily equal in number of photographs; rather, the number in the batch may vary according to three attributes: the frequency of the user's weigh-ins; the number of photographs taken between weigh in intervals; and the period between weigh-ins.

With respect to FIG. 22b, a graphical view of a user's weight chart can be altered by pinching in (or otherwise zooming) horizontally. This provides a longer time period perspective. Further, in this example, six photo batches remain shown; however, the batches may be different in composition from FIG. 22 above. The weight intervals on the y-axis increase (from 6 to 8 in this example) to show weight range over the longer period of time.

FIG. 22C illustrates a graphical view of shorter time period, which can be altered by spreading the x-axis (e.g., taking a narrow pinch and then expanding two fingers out diagonally or horizontally across x-axis). Once performed, the time lapsed and weight parameters provide a shorter-term perspective to the user. Note in this screen that the y-axis intervals changed to 4, and based upon the Users range now adjusted to include decimal points. In some examples, when zooming in, the range of photos shortens, to the point where individual photos can be seen and photo batches are replaced by individual Food Photos. User tapped on any weight in point represented by a dot to see “January 3rd 152 lbs” appear. This is the weigh-in date and the weight previously recorded. The user can further delete weight points as shown in FIG. 22d, for example, by pressing and holding on a weigh-in point (dot). A message can appear to confirm the deletion.

FIG. 22e illustrates a detailed tracker view, in which the user can tap on an area shaded under the weight plotting line to expand the chart (to remove the weigh in input area) so that the graph becomes the size of the full screen. As a user traces a finger over the weight plotting line to see any corresponding Food Photos individually, in sequence, across the time interval. A user may trace back and forth from any point to view the photos in relation to the starting point the user placed his or her finger on.

FIG. 23 depicts an exemplary computing system 1400 configured to perform any one of the above-described processes. In this context, computing system 1400 may include, for example, a processor, memory, storage, camera, and input/output devices (e.g., monitor, keyboard, disk drive, Internet connection, etc.). However, computing system 1400 may include circuitry or other specialized hardware for carrying out some or all aspects of the processes. In some operational settings, computing system 1400 may be configured as a system that includes one or more units, each of which is configured to carry out some aspects of the processes either in software, hardware, or some combination thereof.

FIG. 23 depicts computing system 1400 with a number of components that may be used to perform the above-described processes. The main system 1402 includes a motherboard 1404 having an input/output (“I/O”) section 1406, one or more central processing units (“CPU”) 1408, and a memory section 1410, which may have a flash memory card 1412 related to it. The I/O section 1406 is connected to a display 1424, a keyboard 1414, a disk storage unit 1416, and a media drive unit 1418. The media drive unit 1418 can read/write a computer-readable medium 1420, which can contain programs 1422 and/or data.

At least some values based on the results of the above-described processes can be saved for subsequent use. Additionally, a non-transitory computer-readable medium can be used to store (e.g., tangibly embody) one or more computer programs for performing any one of the above-described processes by means of a computer. The computer program may be written, for example, in a general-purpose programming language (e.g., Pascal, C, C++, Java) or some specialized application-specific language.

Various exemplary embodiments are described herein. Reference is made to these examples in a non-limiting sense. They are provided to illustrate more broadly applicable aspects of the disclosed technology. Various changes may be made and equivalents may be substituted without departing from the true spirit and scope of the various embodiments. In addition, many modifications may be made to adapt a particular situation, material, composition of matter, process, process act(s) or step(s) to the objective(s), spirit or scope of the various embodiments. Further, as will be appreciated by those with skill in the art, each of the individual variations described and illustrated herein has discrete components and features that may be readily separated from or combined with the features of any of the other several embodiments without departing from the scope or spirit of the various embodiments. All such modifications are intended to be within the scope of claims associated with this disclosure.

1. A computer-implemented method for use with a device, the method comprising:
at an electronic device having at least on processor and memory:
receiving an image of food by a first user;
causing communication of the image of the food for delivery to devices of other users; and
receiving feedback from at least one other user based on the communicated image of the food.

2. The method of claim 1, further comprising causing communication of the feedback to the first user.

3. The method of claim 1, wherein the image of the food is transmitted to a set of users previously selected for receipt as coaches, and the received feedback is from a user of the set.

4. The method of claim 3, wherein at least one coach is a life coach.

5. The method of claim 1, wherein the at least one other user includes a previously selected user for receipt of the image of the food.

6. The method of claim 1, wherein the at least one other user is matched to the user based on user profile information.

7. The method of claim 1, wherein the at least one other user is matched to the user based on a questionnaire completed by the user.

8. The method of claim 1, wherein the image of the food is transmitted to a plurality of previously selected coaches, each of which may provide feedback in a binary form to the first user.

9. The method of claim 1, wherein feedback received by the first user are only viewable by the first user and the originating user.

10. The method of claim 1, further comprising receiving an image of food associated with a remote user.

11. The method of claim 8, further comprising receiving feedback by the first user associated with the received image of the food associated with a remote user and causing communication of the feedback to the remote user.

12. The method of claim 1, further comprising a weight tracker for receiving a weight of the first user and plotting the weight over time.

13. The method of claim 1, further comprising associating at least one image of the food with the weight tracker based on the time the image was captured.

14. The method of claim 1, further comprising associating at least two sets of images of the food with the weight tracker based on the time the images were captured, wherein the at least two sets of images are selected from a user's food images based on the time intervals of the weight tracker.

15. The method of claim 1, further comprising displaying a graph of weight over time, the graph having at least one image associated with the time axis.

16. The method of claim 1, further comprising causing the display of a set of coaches to potentially share the photo, wherein in response to selection of a coach from the set of coaches, blurring the photo into the background, and causing the display of a message interface.

17. The method of claim 1, further comprising receiving a recipe from the first user and providing a credit to the first user, wherein the credit can be used to access a recipe of a second user.

18. The method of claim 1, wherein in response to feedback from the at least one other user a notification is sent to the first user.

19. A non-transitory computer-readable storage medium storing one or more programs, the one or more programs comprising instructions, which when executed by an electronic device with a display, cause the device to:
receive an image of food by a first user;
cause communication of the image of the food for delivery to devices of other users; and
receive feedback from at least one other user based on the communicated image of the food.

20. The non-transitory computer-readable storage medium of claim 19, further comprising instructions for causing communication of the feedback to the first user.

21. The non-transitory computer-readable storage medium of claim 19, further comprising instructions for display a weight tracker for displaying the weight of the first user over time, and associating at least one image of the food with the weight tracker based on the time the image was captured.

22. An electronic device, comprising:
a memory; and
a processor coupled to the memory, the memory comprising instructions operable to cause the processor to:
receive an image of food by a first user;
cause communication of the image of the food for delivery to devices of other users; and
receive feedback from at least one other user based on the communicated image of the food.

23. The electronic device of claim 22, further comprising causing communication of the feedback to the first user.

24. The electronic device of claim 22, further comprising causing the display of a weight tracker for displaying the weight of the first user over time, and associating at least one image of the food with the weight tracker based on the time the image was captured.
